(19) United States
(12) Patent Application Publication
(10) Pub. No.: US 2015/0205379 A1
(43) Pub. Date: Jul. 23, 2015

(54) Motion-Detected Tap Input

(71) Applicant: Apple Inc., Cupertino, CA (US)

(72) Inventors: Stefan C. Mag, San Francisco, CA (US); Matthew P. Rao, San Francisco, CA (US)

(73) Assignee: Apple Inc., Cupertino, CA (US)

(21) Appl. No.: 14/245,955

(22) Filed: Apr. 4, 2014

Related U.S. Application Data
(60) Provisional application No. 61/929,481, filed on Jan. 20, 2014.

(51) Int. Cl. G06F 3/0346; G06F 3/01; G06F 3/0488; G06F 3/038; G06F 1/16

(52) U.S. Cl. CPC G06F 3/0346; G06F 3/038; G06F 1/1626; G06F 3/0488; G06F 3/017; G06F 2203/0381; G06F 2203/04808

(57) ABSTRACT

Some embodiments of the invention provide one or more novel motion-detected, tap-input methods for initiating one or more particular operations of a device. In some embodiments, these methods detect a tap input without relying on the output of a touch-sensitive screen sensor, which the device may or may not have. Instead, these methods detect the tap input by relying on the output of one or more other motion sensors of the device. Examples of such motion sensors include accelerometers, gyroscopes, and other sensors that generate output based on the movement of, or physical interactions with, the device.

### CLAIM OF BENEFIT TO PRIOR APPLICATION

This applications claims benefit to prior filed U.S. Provisional Patent Application 61/929,481, filed on Jan. 20, 2014. U.S. Provisional Patent Application 61/929,481 is incorporated herein by reference.

### BACKGROUND

Many mobile devices provide various input mechanisms to allow users to interact with the devices. Examples of such input mechanisms include touch, tactile and voice inputs. Some of these devices, however, place restrictions on the input mechanisms that may slow down user interaction. For instance, typically, a device with touch-sensitive screen has a locked-screen mode that provides reduced touch-screen functionality, in order to prevent inadvertent interactions with the device. Such a locked-screen mode is beneficial in reducing inadvertent interactions, but this benefit comes at the expense of requiring the user to go through certain operations to unlock the locked screen. Accordingly, there is a need in the art for additional input mechanisms that allow a user quicker access to some of the functionalities of the mobile devices.

### BRIEF SUMMARY

Some embodiments of the invention provide one or more novel motion-detected, tap-input methods for initiating one or more particular operations of a device. In some embodiments, these methods detect a tap input without relying on the output of a touch-sensitive screen sensor, which the device may or may not have. Instead, these methods detect the tap input by relying on the output of one or more other motion sensors of the device. Examples of such motion sensors include accelerometers, gyroscopes, and other sensors that generate output based on the movement of, or physical interactions with, the device.

The method of some embodiments initially detects an occurrence of an external event. The external event may be for example, the receipt of a phone call, the triggering of an alarm, the receipt of a text message, or various other types of events that generally require a response from the user. In some embodiments, the external event times out if there is no responsive action by the user (such as a phone call going to voice mail). Also, in some embodiments, the event is viewed as an external event as it occurs independently of the method that initiates the particular operation.

After detecting the occurrence of the external event, the method of some embodiments determines whether the device receives a particular number of motion-detected, tap inputs within a particular time interval. The method makes this determination by examining the output of one or more motion sensors of the device. As mentioned above, examples of such motion sensors include the device's accelerometer, gyroscope, and/or other sensors that generate output based on the movement of, or physical interactions with, the device. Upon detecting the external event and then detecting the particular number of motion-detected, tap inputs with a predetermined time interval, the method directs a module of the device to initiate the particular operation. Examples of such an initiated operation include answering a phone call, or sending the phone call to voice mail, when the external event is the receipt of a phone call, or snoozing an alarm when the external event is a triggered alarm.

The operation-initiation method of some embodiments initiates a particular operation without having an external triggering event. In particular, the method of some embodiments initially detects that the device has a particular orientation. The method of these embodiments then determines whether the device receives a particular number of motion-detected, tap inputs within a particular time interval. This determination is based on the output of one or more motion sensors (such as an accelerometer, a gyroscope, etc.). When the method detects that the device has a particular orientation and then determines that the device has received a particular number of motion-detected, tap inputs within a particular time interval, the method directs a module of the device to perform the particular operation. In order to direct the module to perform the particular operation, the method of some embodiments requires that the detected number of tap inputs occur within a short duration after the method detects that the device has the particular orientation. One example of an operation that some embodiments initiate in response to motion-detected, tap inputs on the device in a particular orientation includes the launching of a camera application upon detecting a certain number of motion-detected, tap inputs within a certain time interval after detecting that the device has been rotated into a particular orientation (e.g., landscape).

In order to identify motion-detected tap inputs, the methods of different embodiments use output data from different motion sensors, or use different combinations of output data from different combinations of motion sensors. In some embodiments, the method may collect, process and store sensor data from the motion sensors using one or more reduced power co-processing units (e.g., the Apple™ M7™) that execute concurrently with the central processing units (CPU) of the device. The reduced power processing units can collect and process data even when the device is both asleep and powered on. Furthermore, the co-processing units are able to offload the collecting and processing of sensor data from the main CPU(s) of the device.

Furthermore, in order to determine whether particular operations should be initiated, the methods of some embodiments augment the output data from the motion sensor data with output data from non-motion sensor data (e.g., with output data from the touch-sensitive screen sensor or with output data from the location identification sensor(s)). Also, in some embodiments, the methods specify different sets of rules for initiating different operations based on the motion-detected, tap inputs that are detected under different conditions. For instance, in some embodiments, each specified rule is based on either: (1) an external event and corresponding set of motion-detected, tap inputs that are detected after the external event, or (2) a particular orientation of the device and a corresponding set of motion-detected tap inputs that are received within a time period after the device has been placed in the particular orientation.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purposes of explanation, several embodiments of the invention are set forth in the following figures.

FIG. 1 illustrates an example software architecture of an operation initiator of some embodiments of the invention.

FIG. 2 illustrates an example for using the operation initiator to snooze an alarm.

FIG. 3 illustrates an example for using the operation initiator to turn off an alarm.

FIG. 4 illustrates different examples of setting different snooze times based on motion-detected tap inputs.

FIG. 5 illustrates an example of an external event that is triggered by an external source and the device subsequently detecting a particular set of tap inputs for launching a particular operation.

FIG. 6 illustrates the device detecting a particular number of tap inputs for answering a telephone call.

FIG. 7 conceptually illustrates a process of some embodiments for initiating an operation based on the occurrence of an external event and the subsequent detection of a particular set of inputs.

FIG. 8 illustrates an example of a software architecture of some embodiments for detecting and responding to different external events triggered by different sources.

FIG. 9 illustrates an example of a software architecture of an operation initiator of some embodiments of the invention.

FIG. 10 illustrates an example of using orientation and a set of tap inputs to launch a series of operations.

FIG. 11 illustrates an example of a device receiving a set of tap inputs within a particular time period after moving into a landscape orientation.

FIG. 12 illustrates using orientation and motion-detected tap inputs to turn on a flashlight on a device.

FIG. 13 conceptually illustrates a process for initiating an operation based on a detected orientation of a device and the subsequent detection of a particular set of motion-detected tap inputs.

FIG. 14 is an example of an architecture of a mobile computing device.

FIG. 15 conceptually illustrates another example of an electronic system with which some embodiments of the invention are implemented.

FIG. 16 is an example of detecting an external event on a first device, receiving tap inputs on a second device, and performing operations on the first device in response to the tap inputs.

FIG. 17 illustrates an example of a user placing a phone in a particular orientation in front of himself and then taking a picture by tapping on a watch that communicatively couples to the phone.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide one or more novel motion-detected, tap-input methods for initiating one or more particular operations of a device. In some embodiments, these methods detect a tap input without relying on the output of a touch-sensitive screen sensor, which the device may or may not have. Instead, these methods detect the tap input by relying on the output of one or more other motion sensors of the device. Examples of such motion sensors include accelerometers, gyroscopes, and other sensors that generate output based on the movement of, or physical interactions with, the device.

The method of some embodiments initially detects an occurrence of an external event. The external event may be for example, the receipt of a phone call, the triggering of an alarm, the receipt of a text message, or various other types of events that generally require a response from the user. In some embodiments, the external event times out if there is no responsive action by the user (such as a phone call going to voice mail). Also, in some embodiments, the event is viewed as an external event as it occurs independently of the method that initiates the particular operation.

After detecting the occurrence of the external event, the method of some embodiments determines whether the device receives a particular number of motion-detected, tap inputs within a particular time interval. The method makes this determination by examining the output of one or more motion sensors of the device. As mentioned above, examples of such motion sensors include the device's accelerometer, gyroscope, and/or other sensors that generate output based on the movement of, or physical interactions with, the device. Upon detecting the external event and then detecting the particular number of motion-detected, tap inputs with a predetermined time interval, the method directs a module of the device to initiate the particular operation. Examples of such an initiated operation include answering a phone call, or sending the phone call to voice mail, when the external event is the receipt of a phone call, or snoozing an alarm when the external event is a triggered alarm.

The operation-initiation method of some embodiments initiates a particular operation without having an external triggering event. In particular, the method of some embodiments initially detects that the device has a particular orientation. The method of these embodiments then determines whether the device receives a particular number of motion-detected, tap inputs within a particular time interval. This determination is based on the output of one or more motion sensors (such as an accelerometer, a gyroscope, etc.). When the method detects that the device has a particular orientation and then determines that the device has received a particular number of motion-detected, tap inputs within a particular time interval, the method directs a module of the device to perform the particular operation. In order to direct the module to perform the particular operation, the method of some embodiments requires that the detected number of tap inputs occur within a short duration (e.g., within a few seconds) after the method detects that the device has the particular orientation. One example of an operation that some embodiments initiate in response to motion-detected, tap inputs on the device in a particular orientation includes the launching of a camera application upon detecting a certain number of motion-detected, tap inputs within a certain time interval after detecting that the device has been rotated into a particular orientation (e.g., landscape).

In order to identify motion-detected tap inputs, the methods of different embodiments use output data from different motion sensors, or use different combinations of output data from different combinations of motion sensors. In some embodiments, the method may collect, process and store sensor data from the motion sensors using reduced power co-processing units (e.g., the Apple™ M7™) that execute concurrently with a central processing unit (CPU) of the device. The reduced power processing units can collect and process data even when the device is both asleep and powered on. Furthermore, the co-processor is able to offload the collecting and processing of sensor data from the main central processing unit (CPU).

To determine whether particular operations should be initiated, the methods of some embodiments augment the output data from the motion sensor data with output data from non-motion sensor data (e.g., with output data from the touch-sensitive screen sensor or with output data from the location identification sensor(s)). Also, in some embodiments, the methods specify different sets of rules for initiating different operations based on the motion-detected, tap inputs that are detected under different conditions. For instance, in some embodiments, each specified rule is based on either: (1) an external event and corresponding set of motion-detected, tap inputs that are detected after the external event, or (2) a particular orientation of the device and a corresponding set of motion-detected tap inputs that are received within a time period after the device has been placed in the particular orientation.

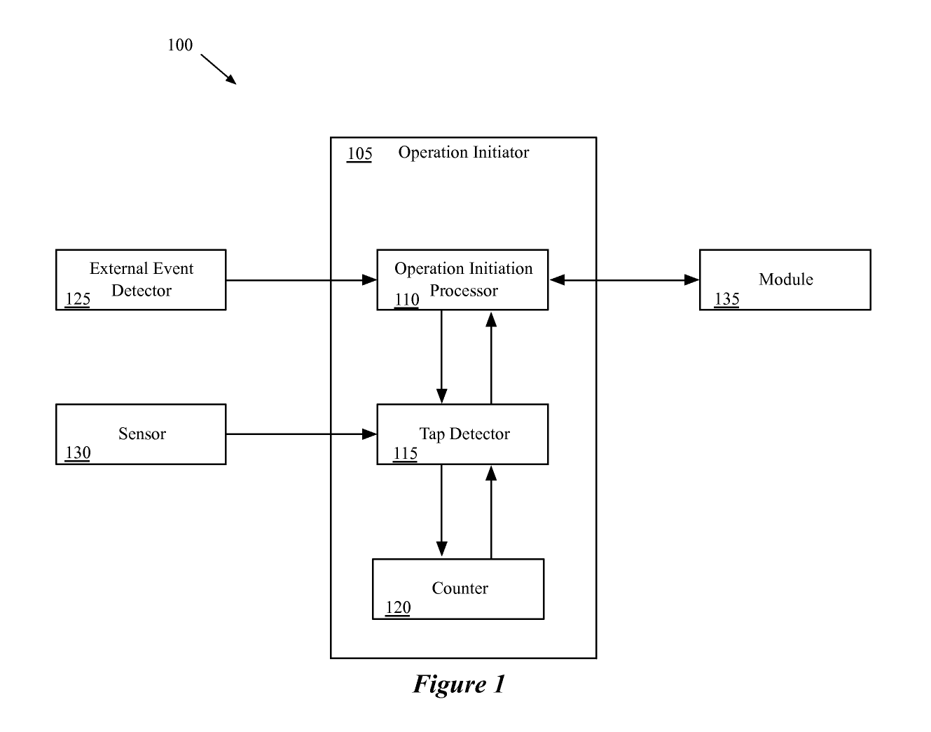

FIG. 1 illustrates an operation initiator module 105 that implements the operation initiation method of some embodiments of the invention. The operation initiator 105 executes on a device (not shown), and directs a module 135 of the device to perform an operation in response to a particular number of motion-detected, tap inputs that occur after an external event and that meet a certain timing constraint. As shown in FIG. 1, the operation initiator 105 includes an operation initiation processor 110, a tap detector 115 and a counter 120. This figure also shows that the operation initiator 105 communicates with external event detector 125, a motion sensor 130, and the module 135.

The external event detector 125 detects external events and notifies the operation initiator 105 of these events. In some embodiments, the external event detector 125 notifies the operation initiator of the events for which the operation initiator 105 has requested to receive notifications (e.g., has registered for callbacks from the detector 125 on occurrence of an event). The external events include events that are triggered from an external source outside of the mobile device or events that are triggered from an internal source within the mobile device. These events are referred to as external events as they occur outside of the operation of the operation initiator 105. Examples of events triggered from external sources include the receipt of a phone call, text message, face-time® request, e-mail message, or any other event that is sent from a source that is external to the mobile device. Examples of external events triggered from an internal source include a triggered alarm, a calendar notification, detecting that the device is in a particular orientation, or any other event that is triggered from a source that is internal on the mobile device. While shown as a module external to the operation initiator 105 in FIG. 1, one of ordinary skill in the art will realize that in other embodiments the event detector 125 is one of the internal modules of the operation initiator 105.

Upon receiving the notification of the occurrence of a particular event from the external event detector 125, the operation initiation processor 110 directs the tap detector 115 to monitor the output data from the motion sensor 130 to determine whether the device will receive a particular number of motion-detected tap inputs that meets a timing constraint. If the tap detector 115 determines that the device receives a particular number of motion-detected tap inputs that meet the timing constraint, the tap detector notifies the operation initiation processor 110 of the reception of the requisite number of tap inputs, which then causes the processor 110 to direct the module 135 to initiate a particular operation.

In some embodiments, the tap detector 115 performs three different operations in connection with tap inputs. These operations are (1) registering each tap input, (2) directing the counter 120 to increment a tap count each time that the detector 115 registers a new tap, and (3) notifying the processor 110 of the reception of the requisite number of tap inputs that meet the timing constraint. Tap detector 115 uses different timing constraints in different embodiments. For instance, in some embodiments, the tap detector enforces a timing constraint that is defined as an overall period of time in which all the tap inputs have to be received. In other embodiments, the timing constraint is defined in terms of a relative timing constraint that requires that each received tap input occur within a certain time period of another tap input. In still other embodiments, the timing constraint is defined in terms of both an overall first time period (i.e., a time period in which all the tap inputs have to be received) and a relative second time period (i.e., a constraint that requires that each tap be received within a certain time period of another tap).

In yet other embodiments, the tap detector 115 specifies that the requisite number of tap inputs that meet the timing constraint, have been received (which may be defined in terms of an overall time period, a relative time period, or both) only when it detects the requisite number of taps while the detected event is active (e.g., has not timed out). For instance, when the external event is a phone call or an alarm notification, the tap detector in these embodiments only provides indication of the requisite number of taps when it detects these taps while the phone is still ringing (i.e., the caller has not hung up and the call has not gone to voicemail) or the alarm notification is still going off (e.g., sounding off and/or vibrating the device). In some embodiments, any of the above-mentioned timing constraints also includes a constraint that the requisite number of taps is detected within a particular time period from when the external event is first detected. A timing constraint allows for a greater level of certainty that the user actually intends an actual operation to be performed because it requires the user to perform a certain sequence of taps that meet the timing constraint; such a constraint also reduces the chances of performing an operation inadvertently by detecting several accidental taps. Having the timing constraint that includes multiple different components (e.g., an overall duration combined with a relative duration or a starting constraint) increases the certainty regarding the user's intent and reduces the chances of initiating an operation by detecting accidental taps.

The tap detector 115 detects new taps differently in different embodiments. For instance, once the processor 110 directs the tap detector to monitor the output of the motion sensor 130 to detect the requisite number of taps, the tap detector 115 of some embodiments (1) continuously monitors the output data that the motion sensor 130 produces, and (2) generates a “tap” signal when the tap detector determines that the monitored output for a duration of time is indicative of a tap on the device. In these embodiments, the motion sensor 130 produces an output signal that at each instance in time is indicative of the motion of the device at that instance in time.

One example of such a motion sensor is an accelerometer, which is able to detect movement of the device, including acceleration and/or de-acceleration of the device. The accelerometer may generate movement data for multiple dimensions that may be used to determine the overall movement and acceleration of the device. For example, the accelerometer may generate X, Y, and/or Z axes acceleration information when the accelerometer detects that the device moves in the X, Y, and/or Z axes directions. In some embodiments, the accelerometer generates instantaneous output data (i.e., output data for various instances in time) that when analyzed over a duration of time can provide indication of an acceleration in a particular direction, which, in turn, is indicative of a directional tap (i.e., a directed motion) on the device.

Even when the device is on a flat solid surface, the accelerometer of some embodiments can provide output data that specifies an “acceleration” in a particular direction. In some embodiments, the acceleration output data can detect “shock” data that is representative of the device's vibration, which often in such cases is non-periodic vibrations. In some such embodiments, the accelerometer is particularly mounted within the device (e.g., mounted with a desired degree of rigidity within the device) so that it can detect shock data when the device starts having minor vibrations after being tapped while laying on a surface. One of ordinary skill in the art will realize that the accelerometer in some embodiments might not be able to detect shock data or it might not have the proper mounting within device to be able to detect shock data. In some of these embodiments, the accelerometer is not used to detect taps while the device lays on a surface.

In some embodiments, the accelerometer's output is provided with respect to gravity. For instance, in some embodiments, the accelerometer's output data is specified in terms of a vector that has a magnitude and a direction, with the direction being specified in terms of the sign (positive or negative) of the vector and an angle that is defined with respect to the direction of gravity. In some embodiments, the accelerometer's output data is specified for the different coordinate axes (X, Y, and Z) by correlating to these axes the output data that is received in terms of the above-described vector. Such accelerometer data (e.g., data correlated to the X, Y, and Z axes) is used in some embodiments to determine the location of the tap (e.g., on the side edge of device, front screen, back side, etc.).

In several of the examples provided below, the tap detector of some embodiments is described as a module that continuously monitor the outputs of the motion sensor and generates a tap signal whenever it determines that the monitored output data for a duration of time is indicative of a tap on the device. The tap detector in these embodiments directs the tap counter to increment the tap count each time that a tap signal meets the timing constraint enforced by the tap detector. When the tap counter has counted a particular number of taps that meet the enforced timing constraint, the tap detector notifies the operation initiation processor 110 that the requisite number of taps have been received for the detected external event.

In other embodiments, however, the tap detector detects new taps differently. For instance, in some embodiments, the tap signal is generated by the motion sensor 130 itself In these embodiments, the tap detector simply receives the tap signal and increments the tap count when the received tap signal meets the enforced timing constraint. Again, when the tap counter has counted a particular number of taps that meet the enforced timing constraint, the tap detector of these embodiments notifies the operation initiation processor 110 that the requisite number of taps have been received for the detected external event.

In still other embodiments, the tap signal is neither generated by the tap detector 115 nor the motion sensor 130. For instance, in some embodiments, a module of the device's operating system (e.g., a function in the OS (operating system) framework) continuously monitors the outputs of the motion sensor and generates a tap signal whenever it determines that the monitored output data for a duration of time is indicative of a tap on the device. In some embodiment, the tap detector 115 would register with the OS module (e.g., with the OS framework) in order to be notified of such tap output signals. Once the processor 110 directs the tap detector 115 to monitor the output of the motion sensor 130 to detect the requisite number of taps, the tap detector 115 of some embodiments checks the output of the OS module that generates the tap output signals, and directs the tap counter to increment the tap count each time that it receives a tap output signal form this module that meets the timing constraint enforced by the tap detector. Once again, when the tap counter has counted a particular number of taps that meet the enforced timing constraint, the tap detector of these embodiments notifies the operation initiation processor 110 that the requisite number of taps have been received for the detected external event.

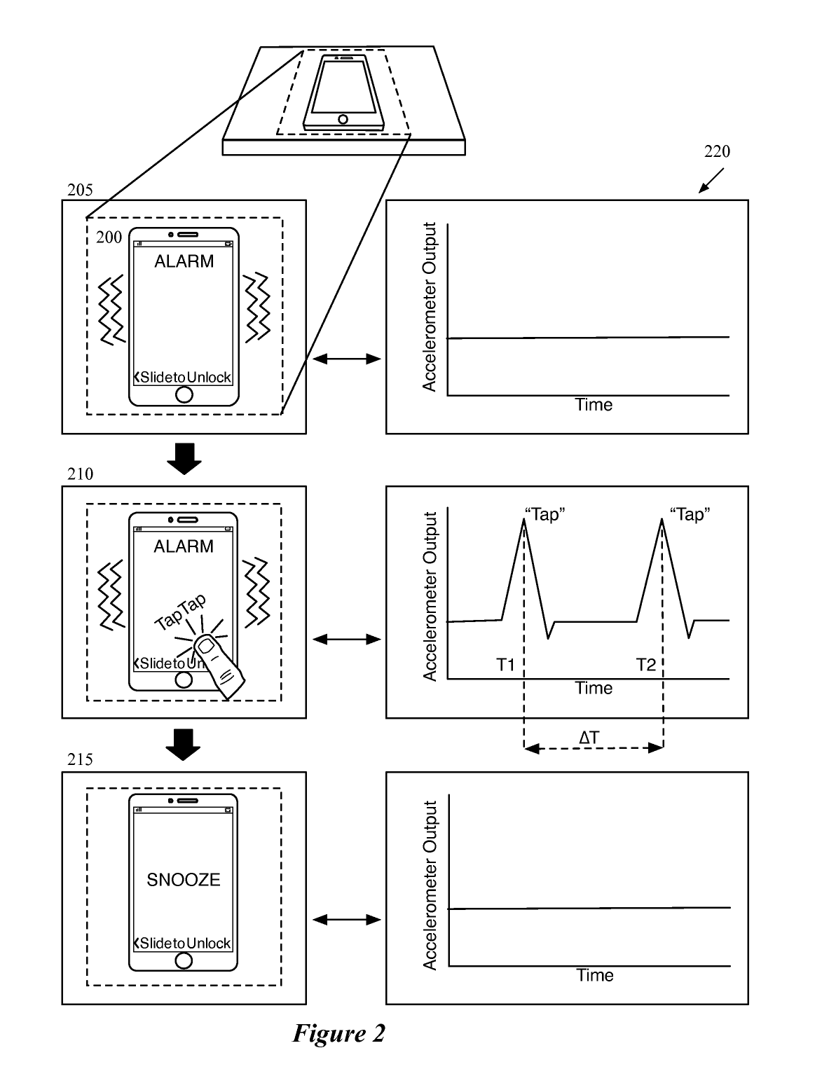

The operations of the operation initiator 105 will now be described with reference to FIG. 2. This figure illustrates an example of the operation initiator 105 of a mobile device 200 snoozing an alarm notification that is generated by the device 200 upon detecting two motion-sensed tap inputs after the alarm notification goes off This example is illustrated in three stages 205-215 that correspond to the occurrence of the external event (which in this example is the triggering of the alarm notification), the receipt of a number of tap inputs, and the execution of an operation on the mobile device (which in this example is the snoozing of the alarm notification). Each stage also illustrates a graph of the output data of the motion sensor 130, which in this example is an accelerometer of the mobile device that generates the alarm notification. The graph of each stage is specified by an x-axis that represents time and a y-axis that represents motion data detected by the accelerometer.

As shown in FIG. 2, the first stage 205 illustrates the triggering of an alarm on the mobile device. As described above, the alarm is triggered from an internal source (unlike, for example, the receipt of a phone call) since the mobile device triggered the alarm notification based on an internally specified time for the alarm. However, in some embodiments, a user of the device typically sets this alarm manually at an earlier time. As shown in FIG. 2, the device is placed flat on a surface (e.g., a desk) when the alarm notification goes off As described below, some embodiments consider the particular orientation of the device (e.g., laying flat on a surface) when determining whether to initiate a particular operation.

Upon the triggering of the alarm notification, the external event detector 125 notifies the operation initiation processor 110 of the operation initiator 105 of the occurrence of the alarm notification. In response, the processor 110 directs the tap detector 115 to determine whether a certain number of taps are made on the device within a certain time period of each other (i.e., “x” taps within “y” seconds of each other).

When the device receives a tap input, the device's accelerometer generates a series of motion based data, which, as described above, can be used to detect application of directional force in a particular direction on the device and/or at a particular location on the device. In some embodiments, the output data of the accelerometer is sent to the tap detector 115. The tap detector 115 then analyzes this output motion data in order to determine whether the device has received a tap input. When the tap detector 115 determines that the device has received a tap input that satisfies a timing constraint that is enforced by the tap detector, it notifies the counter 120 of the tap input in order for the counter to increment a count of the number of received taps.

The second stage 210 of FIG. 2 illustrates the mobile device receiving two tap inputs (illustrated as the “tap tap”) on the screen of the mobile device. Furthermore, the graph of the accelerometer output in this stage illustrates movement data that corresponds to the two taps. As shown in this stage, each tap causes the accelerometer to generate a series of output data that results in a spike in the graph. At some point while analyzing the series of output data that results in the spike (e.g., while the output data increases past a first threshold and subsequently starts to decrease within a time period after passing the first threshold), the tap detector determines whether the series of output data signifies the occurrence of a tap. If the detected tap meets a timing constraint, the tap detector then directs the counter 120 to increment the tap count. In this example, the tap detector detects the occurrence of two taps at times T1 and T2. Also, in this example, the tap detector recognizes the first tap as a legitimate tap (i.e., as a tap that meets the enforced timing constraint) as it is the first tap, and then recognizes the second tap as a legitimate tap as it occurs within a particular time interval of the first tap (i.e., recognizes the second tap as the difference ΔT between times T2 and T1 is less than a threshold time period that is enforced by the tap detector 115).

In the example illustrated in FIG. 2, as well as the examples illustrated in the other figures, the accelerometer output data is shown as semi-smooth waveforms that may seem as periodic signals. However, this is rarely the case. When receiving tap inputs from a user, the output of accelerometer is most often aperiodic, and the data can jitter up and down even when generally ascending or generally descending. Accordingly, one of ordinary skill in the art will realize that the representations in the figures are simplified in order to generally represent the accelerometer output data.

In this example, once the tap detector 115 determines that two taps have been received within a particular time period of each other after the alarm notification has gone off, the tap detector 115 notifies the operation initiation processor 110 of the receipt of the two taps. In response, the processor 110 directs the alarm module to initiate a snooze operation that terminates the alarm notification temporarily for a certain time interval before starting the alarm notification once again. The third stage 215 of FIG. 2 illustrates the mobile device 200 after the alarm notification has been snoozed. As mentioned above and further described below, the operation initiator 105 of some embodiments recognizes taps not only based on timing constraints but based on other constraints, such as device-orientation constraints and tap-location constraints. Accordingly, in some embodiments, the operation initiator 105 of the device 200 initiates an operation when the detected taps satisfy both a timing constraint and at least one other constraint (such as a device-orientation or tap-location constraint).

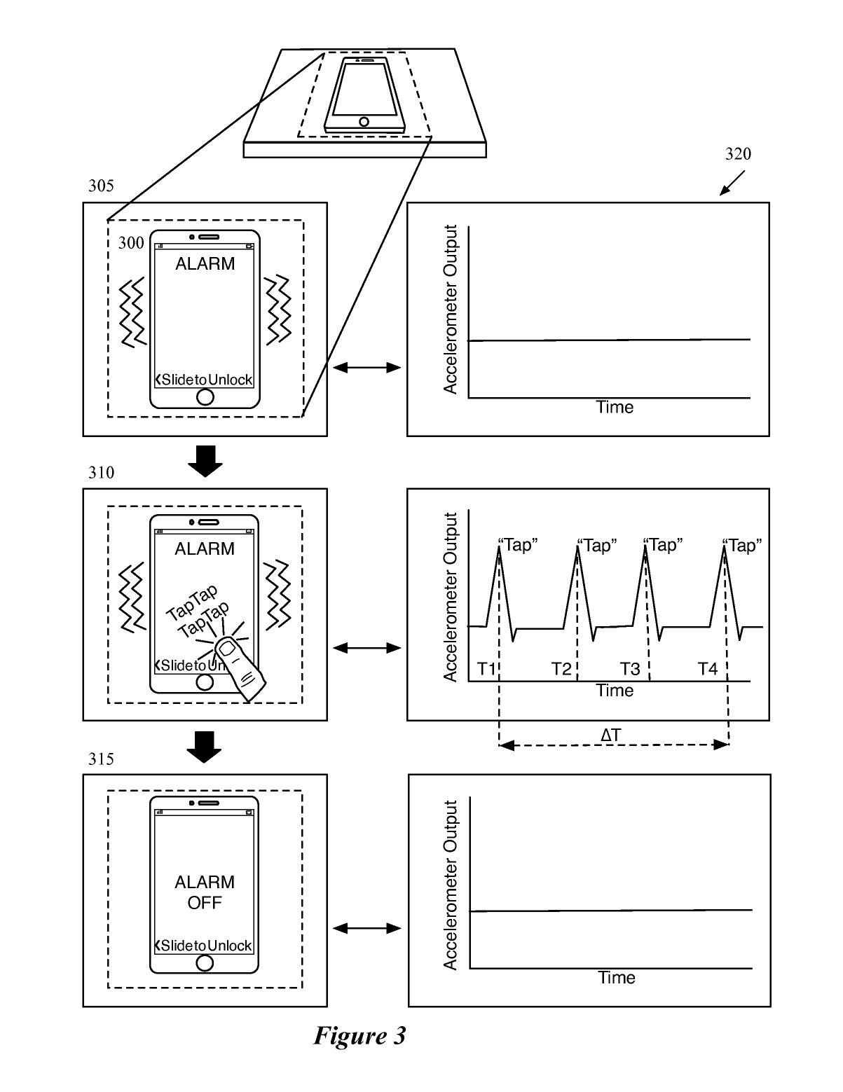

FIGS. 3-6 illustrate four additional examples of the operation initiator of some embodiments performing different operations upon detecting different number of tap inputs that occur after different external events. FIG. 3 illustrates an example in which the operation initiator 105 of a mobile device 300 turns off an alarm notification upon detecting four taps after the alarm notification goes off. This example is illustrated in three stages 305-315 that correspond to the occurrence of an external event (which in this example is the triggering of the device's alarm), the receipt of four taps on a display screen of the device, and the turning off of the alarm notification. Furthermore, each stage illustrates an accelerometer graph 320 that illustrates the output of the accelerometer of the device at different times.

As shown in FIG. 3, the first stage 305 illustrates the triggering of the alarm of the mobile device 300. As described in FIG. 2, upon the triggering of the alarm notification, the external event detector 125 notifies the operation initiation processor 110 of the operation initiator 105 of the occurrence of the alarm notification. At this stage 305, the accelerometer of the mobile device has not yet detected any tap inputs, as indicated by the flat line along the x-axis of the accelerometer graph 320.

The second stage 310 illustrates the device receiving four taps on the display screen of the device. It also shows the accelerometer graph 320 having four spikes along the graph that represent the accelerometer output data that is generated for these four taps at different times T1, T2, T3, and T4. As in the example illustrated in FIG. 2, the tap detector 115 detects each tap by analyzing the series of output data that results in each spike and determining that a series of output data signifies the occurrence of a tap (e.g., noting that the output data keeps increasing until it passes a first threshold and then subsequently starts to decrease within a time period after passing the first threshold). If the detected tap meets a timing constraint, the tap detector then directs the counter 120 to increment the tap count. In the example illustrated in FIG. 3, the tap detector detects the occurrence of four taps at times T1, T2, T3 and T4. Also, in this example, the detector of some embodiments recognizes the first tap as a legitimate tap (i.e., as a tap that meets the enforced timing constraint) as it is the first tap, and then recognizes each of the subsequent second, third and fourth taps as a legitimate tap as each subsequent occurs within a particular time interval of the first tap (e.g., recognizes the third tap as the difference between times T3 and T1 is less than a threshold time period that is enforced by the tap detector 115).

Once the tap detector 115 determines that four taps have been received within a particular time period of each other after the alarm notification has gone off, the tap detector 115 notifies the operation initiation processor 110 of the receipt of the four taps. In response, the processor 110 directs the alarm module to turn off the alarm notification. The third stage 315 of FIG. 3 illustrates the mobile device 300 after the alarm notification has been turned off At this stage, the device is not detecting any other tap inputs, as illustrated by the flat line in the graph 320 of the accelerometer.

Some embodiments account for the orientation of the device while receiving the tap inputs, in order to determine whether to perform an action in response to an external event based on the received tap inputs. Alternatively, or conjunctively, some embodiments account for the location of the device that receives the tap inputs, in order to determine whether to perform an action in response to an external event based on the received tap inputs. In the examples illustrated in FIGS. 2 and 3, the orientation of the device (i.e., the device laying flat on its back surface) and the location for receiving the tap inputs (i.e., the display screen receiving the tap inputs) can be ascertained based on the output of the device's accelerometer, gyroscope and/or touch sensitive screen. In some embodiments, the device's accelerometer provides sufficient data to ascertain the orientation of the device and the location of the tap inputs. This is because the device's accelerometer may constantly or periodically monitor the movement of the portable device. As a result, an orientation of the portable device prior to the movement and after the movement may be determined based on the movement data provided by the accelerometer. However, in some of these embodiments, this data is augmented with the data from the device's other sensors such as gyroscope and/or touch sensitive screen.

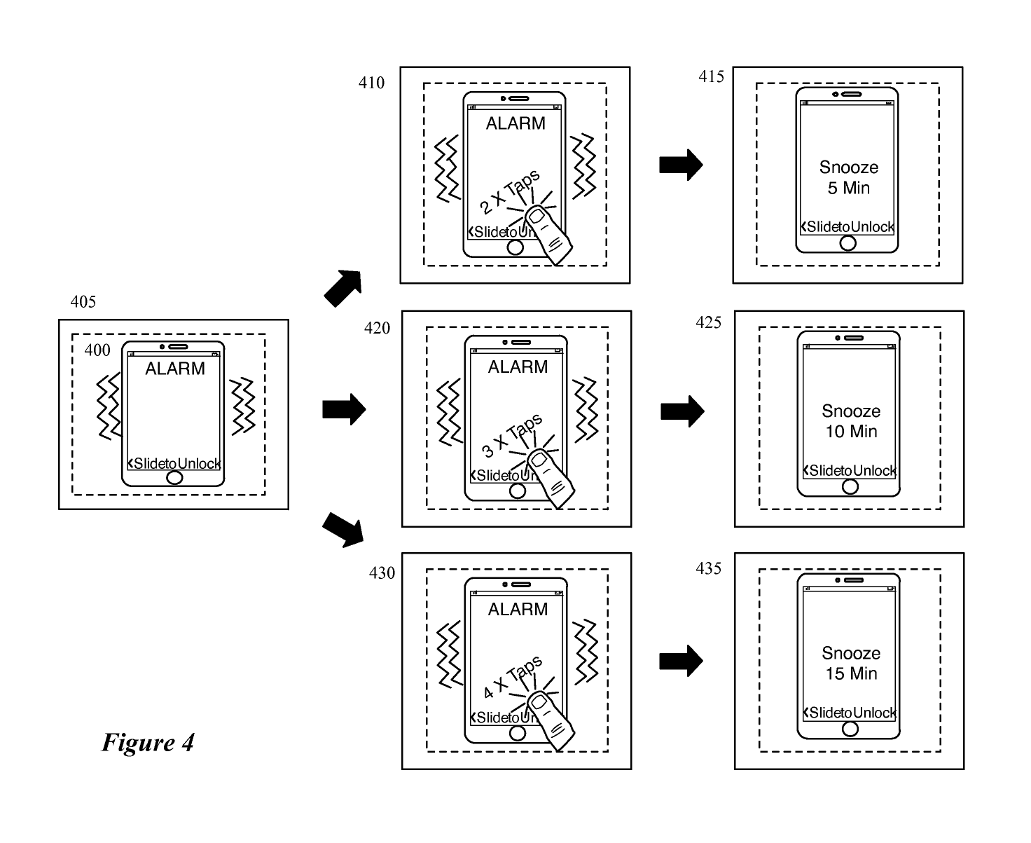

As illustrated by the examples of FIGS. 2 and 3, different number of tap inputs can be used by the operation initiator 105 to perform different operations after the occurrence of an external event. The use of different number of taps to perform different operations is further illustrated in FIG. 4. This figure illustrates three different examples of setting snooze times based on three different types of motion-detected tap inputs. In particular, each example illustrates the device setting a different snooze time based on the particular number of tap inputs that are detected. Each of the three examples is illustrated in three stages that begin with initial stage 405, which illustrates an alarm clock (i.e., external event) that has been triggered on a mobile device. In this example, the alarm clock may be triggered based on a time that has been specified by a user.

The first example 410-415 illustrates the user tapping the device to set a snooze time to 5 minutes. In particular, the stage 410 illustrates two consecutive tapping inputs (illustrated as “2× Taps”) while the alarm notification is going off Based on this particular set of tap inputs, the device sets the snooze time for 5 minutes, as shown in stage 415. In the second example 420-425, the stage 420 illustrates three tap inputs (illustrated as “3× Taps”) while the alarm notification is going off. In response to these three taps, the device sets the snooze time of 10 minutes, as shown in stage 425. The third example 430-435 illustrates the user tapping the device four times (as illustrated as “4× Taps”) while the alarm notification is going off Based on this particular set of tap inputs, the device sets the snooze time for 15 minutes, as shown in stage 435.

While the example illustrated in FIG. 4 increases the snooze time by five minutes, the device of other embodiments may apply a different increase in the amount of snooze time per tap (e.g., a one or ten minute increase), or alternatively may allow the user to configure the increase in snooze time per tap. Furthermore, as described above by reference to FIG. 3, some embodiments may completely turn-off the alarm clock after a certain number of taps have been detected. As mentioned above, some embodiments require that the received tap inputs meet a timing constraint before performing an action and/or require the tap inputs to be received while the particular event is being occurring. For example, if the alarm clock automatically shuts off temporarily after a certain time period (e.g., thirty second), any tap inputs received after the alarm clock has been shut off will not cause the device of some embodiments to perform the particular operation (e.g., to snooze the alarm notification) that would otherwise be performed had the tap inputs been received while the alarm was triggered.

In addition to or instead of timing constraints, the operation initiator 105 of some embodiments uses other constraints before performing a certain operation in response to a series of taps after the occurrence of an external event. Accounting for the orientation of the device and/or the location of the tap inputs allows the operation initiator 105 of some embodiments to place additional constraints for ensuring the user's intent is to perform a particular operation and for reducing the chances of inadvertently performing the particular operation. For instance, in some embodiments, a device (such as the device 200, 400, or 300 of FIG. 2, 4, or 3) snoozes or turns off an alarm notification when the device receives a certain number of tap inputs as it lays flat on a surface. The turn-off operation can be enforced by using a timing constraint for the three taps and using an orientation constraint to ensure that the device is laying flat. Another example would be answering a phone call in response to a series of tap inputs while the device is in a vertical orientation that is suggestive of the device being in a shirt or pant pocket.

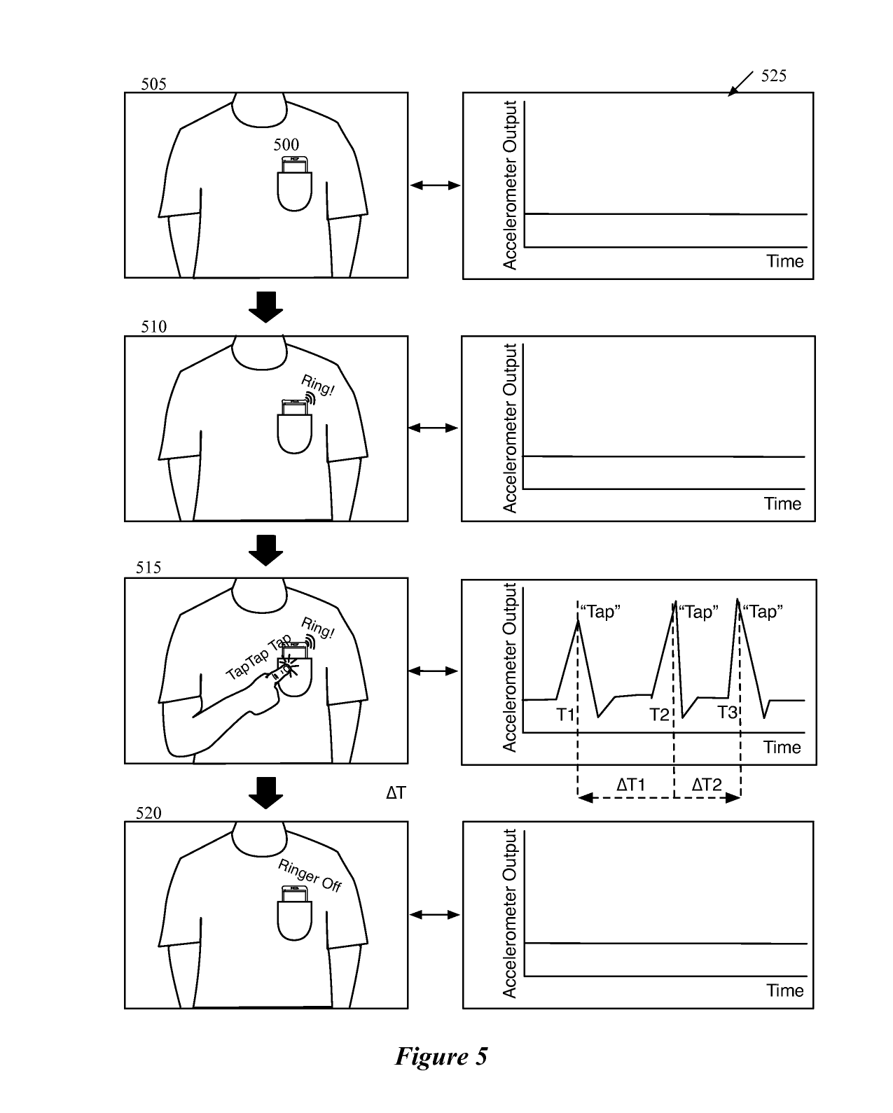

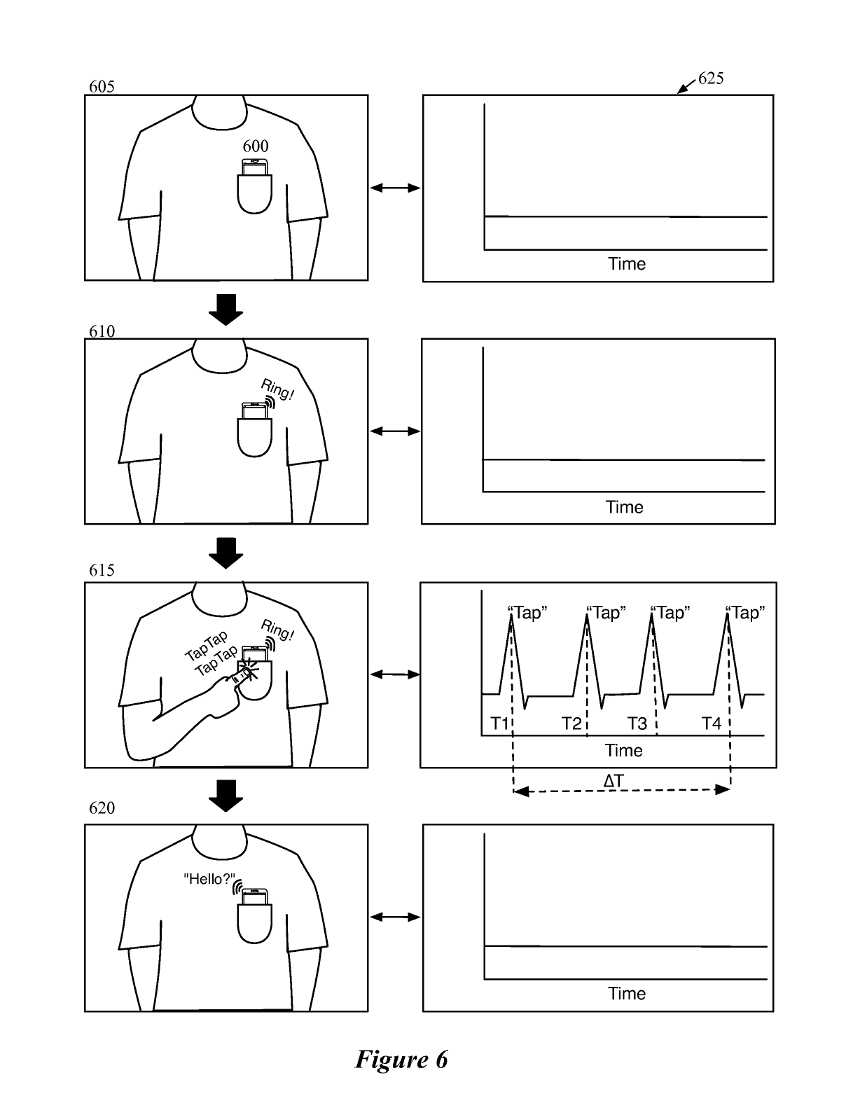

FIGS. 5 and 6 illustrate examples for receiving tap inputs after a vertically-oriented phone receives a phone call and performing actions with respect to the phone call in response to the tap inputs. In some embodiments, these examples are implemented only based on timing constraints. Alternatively, or conjunctively, these examples in some embodiments are implemented based on orientation and/or tap-position constraints.

FIG. 5 illustrates an example for turning off the ringing and/or vibration of the device in response to a received phone call, which is an example of an external event that is triggered by an external source (i.e., triggered by a source that is outside of the mobile device). This example is illustrated in four stages 505-520. Each stage also includes an accelerometer graph 525 that illustrates the accelerator output data that is being detected by the tap detector 115 at different times.

The first stage 505 illustrates a mobile device 500 located in a shirt pocket of a user. In this stage, the mobile device is idle. Accordingly, the accelerometer graph 525 indicates that the device is not detecting any motion data (as illustrated by the flat line in the graph). When the user is moving, the accelerometer often produces motion data as the device 500 moves while in the user's shirt pocket. Accordingly, the flat-line graph in the first stage is a simplification that is made in order not to obscure the description of this figure with unnecessary detail.

The second stage 510 illustrates the mobile device receiving a phone call, as indicated by the “Ring” depicted in this stage. A phone call is an external event that is triggered from an external source (i.e., another phone initiating the phone call). Other examples of external events from external sources include receiving a text message, an email message, a face-time™ request, and various other types of events that are initiated by a source outside of the mobile device.

Upon receiving the phone call, the external event detector 125 notifies the operation initiation processor 110 of the operation initiator 105 of the occurrence of the call. In response, the processor 110 directs the tap detector 115 of some embodiments to determine whether a certain number of taps are subsequently received that meet a timing constraint, while the phone is still ringing. In some embodiments, the tap detector 115 then analyzes this output data from the accelerometer in order to determine whether the device has received a tap input. When the tap detector 115 determines that the device has received a tap input that satisfies a timing constraint that is enforced by the tap detector, it notifies the counter 120 of the tap input in order for the counter to increment a count of the number of received taps.

The third stage 515 illustrates the device receiving three consecutive taps from the user. Accordingly, the accelerometer graph 525 now illustrates three spikes in the output data of the accelerometer at three different times T1, T2, and T3 along the graph. Each spike corresponds to a particular tap received at a particular time. As in the example illustrated in FIGS. 2 and 3, the tap detector 115 detects each tap by analyzing the series of output data that results in each spike and determining that a series of output data signifies the occurrence of a tap (e.g., noting that the output data keeps increasing until it passes a first threshold and then subsequently starts to decrease within a time period after passing the first threshold). To detect each tap, the analysis of the accelerometer output data in some embodiments has to disregard or filter out the motion data that the accelerometer picks up from the user's movement (e.g., user's walking) that is unrelated to the tapping of the device. In some embodiments, this analysis disregards or filters out such unrelated motion data as the motion data generated by the tap is far stronger and transient in nature than the motion data generated by the user's movement, which can have a more periodic nature due to the user's rhythmic movement (e.g., rhythmic walking movement).

If the detected tap meets a timing constraint, the tap detector then directs the counter 120 to increment the tap count. In this example, the tap detector detects the occurrence of three taps at times T1, T2, and T3. Also, in this example, the detector of some embodiments recognizes the first tap as a legitimate tap (i.e., as a tap that meets the enforced timing constraint) as it is the first tap, and then recognizes each of the subsequent second and third taps as a legitimate tap as each subsequent tap occurs within a particular time interval of the first tap (e.g., recognizes the third tap as the difference between times T3 and T1 is less than a threshold time period that is enforced by the tap detector 115). As shown in this example, more than two taps can be accepted even when the time difference between successive pairs of taps in the set of taps is different in some embodiments (i.e., ΔT1 is larger than ΔT2).

Once the tap detector 115 determines that three taps have been received within a particular time period after the call has been received and while the call is still pending, the tap detector 115 notifies the operation initiation processor 110 of the receipt of the three taps. In some embodiments, the tap detector 115 only notifies the processor 110 of the detection of the three taps, and it is the job of the processor 110 to detect whether the call is still pending.

Once the processor 110 notes that the three taps have been detected while the call is still pending, the processor 110 directs the device's phone module to turn off the phone call notification, which can include the phone call audible notification (i.e., the phone call ringing) and/or the phone call vibration notification. The fourth stage 520 of FIG. 5 illustrates the mobile device 500 after the phone call notification has been turned off. In some embodiments, the call is sent to voicemail when the phone call notification is turned off. At this stage, the device is not detecting any other tap inputs, as illustrated by the flat line in the graph of the accelerometer. In some embodiments, neither the tap detector 115 nor the processor 110 checks to determine whether the call is still pending. In these embodiments, the processor 110 simply notifies the phone module to turn off the phone call notification when it is notified of the three taps by the tap detector. If the call is no longer pending, the phone module disregards this notification from the processor 110.

In the above-described example, the operation initiator 105 of the device 500 requires the detected tap inputs to be within a particular time interval after the phone call is detected and while the phone call is pending. In other embodiments, however, the initiator 105 of the device 500 enforces any one of the above-described timing constraints (such as the overall, relative, and/or start timing constraints).

Also, the initiator 105 of this device in some embodiments enforces other device-orientation or tap-location constraints. For instance, in some embodiments, the accelerometer is used to not only detect a tap input, but also an orientation of the device. In general, the accelerometer of some embodiments may continuously or periodically monitor the movement of the portable device. As a result, an orientation of the portable device prior to the movement and after the movement may be determined based on the movement data provided by the accelerometer attached to the portable device. Accordingly, in some embodiments, the initiator 105 uses the accelerometer output to identify the taps and the orientation of the device. In such embodiments, the initiator 105 of the device 500 would detect in the third stage 515 that three taps are received on the front of the device as the device has a vertical orientation. Each tap is specified by a set of acceleration data output by the accelerometer of the device.

When the timing and orientation constraints are satisfied by three taps on the front side of the device within a particular time interval after a call, the initiator 105 directs the phone module to turn off the phone call notification. Using the orientation information allows the device to distinguish, for example, taps on the device while the device is located in a shirt pocket versus inconsequential interactions with the device while the device is in other positions (e.g., while the device is being held in the user's hand). Furthermore, by allowing the tap inputs when the device is in a particular orientation that would exist in certain common situation (such as the device being upright in a shirt pocket or laying flat on a surface), the user would be able to perform the tap operations in order to avoid having to, for example, remove the mobile device from their shirt pocket, etc. As described above and further described below, the operation initiator of some embodiments uses other sensors instead of or in conjunction with the output of the accelerometer to determine whether tap inputs meet timing, device-orientation, or tap-location constraints.

In some embodiments, taps on the back of the device 500 would also be detected. In some of these embodiments, such detected taps would also direct the phone module to turn off the phone call notification. In other embodiments, such detected taps on the back side of the device 500 would not direct the phone module to turn off the phone call notification, but instead might direct this module or another module to perform another operation (e.g., to answer the phone call) or might be ignored for the particular phone call notification event.

FIG. 6 illustrates another example in which the operation initiator 105 of a mobile device 600 performs an operation in response to tap inputs while the device is vertically oriented in a user's shirt pocket. In this example, the initiator 105 causes the device to pick up a phone call upon detecting four taps after the phone call notification (e.g., ringer and/or vibrator) goes off. This example is illustrated in four stages 605-620 that correspond to the device in an idle state, the occurrence of an external event (which in this example is the reception of the phone call), the receipt of four taps on a display screen of the device, and the answering of the phone call. Furthermore, each stage illustrates an accelerometer graph 625 that illustrates the output of the accelerometer of the device at different times.

The first stage 605 illustrates the device in an idle state while in a shirt pocket of the user. In this state, the accelerometer graph 625 indicates that the device is not detecting any tap inputs as the graph is a flat line. The second stage 610 illustrates the device receiving a phone call, as shown by the ringing of the device. As described above, this external event is being triggered from an external source (i.e., the person initiating the phone call). In this state, the accelerometer graph 625 still indicated that the device is not detecting any tap inputs as the graph is a flat line. When the ringing is accompanied by vibration, the accelerometer of some embodiment may pick up some insignificant movement of the device and hence it may generate some inconsequential output data, which gets ignored by the tap detector as noise.

The third stage 615 illustrates the device receiving four tap inputs (illustrated as “Tap Tap Tap Tap”) on the front/back side of the device while the phone is ringing. It also shows the accelerometer graph 625 to now illustrate four spikes in the output data of the accelerometer at four different times T1, T2, T3 and T4 along the graph. Each spike corresponds to a particular tap received at a particular time. As in the example illustrated in FIGS. 2, 3, and 5, the tap detector 115 detects each tap by analyzing the series of output data that results in each spike and determining that a series of output data signifies the occurrence of a tap. If the detected tap meets a timing constraint, the tap detector then directs the counter 120 to increment the tap count. In this example, the tap detector detects the occurrence of four taps at times T1, T2, T3, and T4. Also, in this example, the detector of some embodiments recognizes the first tap as a legitimate tap (i.e., as a tap that meets the enforced timing constraint) as it is the first tap, and then recognizes each of the subsequent second, third, and fourth taps as a legitimate tap as each subsequent tap occurs within a particular time interval of the first tap (e.g., recognizes the fourth tap as the difference between times T4 and T1 is less than a threshold time period that is enforced by the tap detector 115).

Once the tap detector 115 determines that four taps have been received within a particular time period after the call has been received and while the call is still pending, the tap detector 115 notifies the operation initiation processor 110 of the receipt of the four taps. In some embodiments, the tap detector 115 only notifies the processor 110 of the detection of the four taps, and it is the job of the processor 110 to detect whether the call is still pending.

Once the processor 110 notes that the four taps have been detected while the call is still pending, the processor 110 directs the device's phone module to answer the phone call. The fourth stage 620 of FIG. 6 illustrates the mobile device 600 after the phone call has been picked up, as indicated by the “Hello” illustrated in this figure. At this stage, the device is not detecting any other tap inputs, as illustrated by the flat line in the graph of the accelerometer. In some embodiments, neither the tap detector 115 nor the processor 110 checks to determine whether the call is still pending. In these embodiments, the processor 110 simply notifies the phone module to pick up the phone call when it is notified of the four taps by the tap detector. If the call is no longer pending, the phone module disregards this notification from the processor 110.

In the above-described example, the operation initiator 105 of the device 600 requires the detected tap inputs to be within a particular time interval after the phone call is detected and while the phone call is pending. In other embodiments, however, the initiator 105 of the device 600 enforces any one of the above-described timing constraints (such as the overall, relative, and/or start timing constraints). Also, the initiator 105 of this device 600 in some embodiments enforces other device-orientation or tap-location constraints. Examples of such constraints were described above for several figures, including FIG. 5. These examples are equally applicable to the example illustrated in FIG. 6.

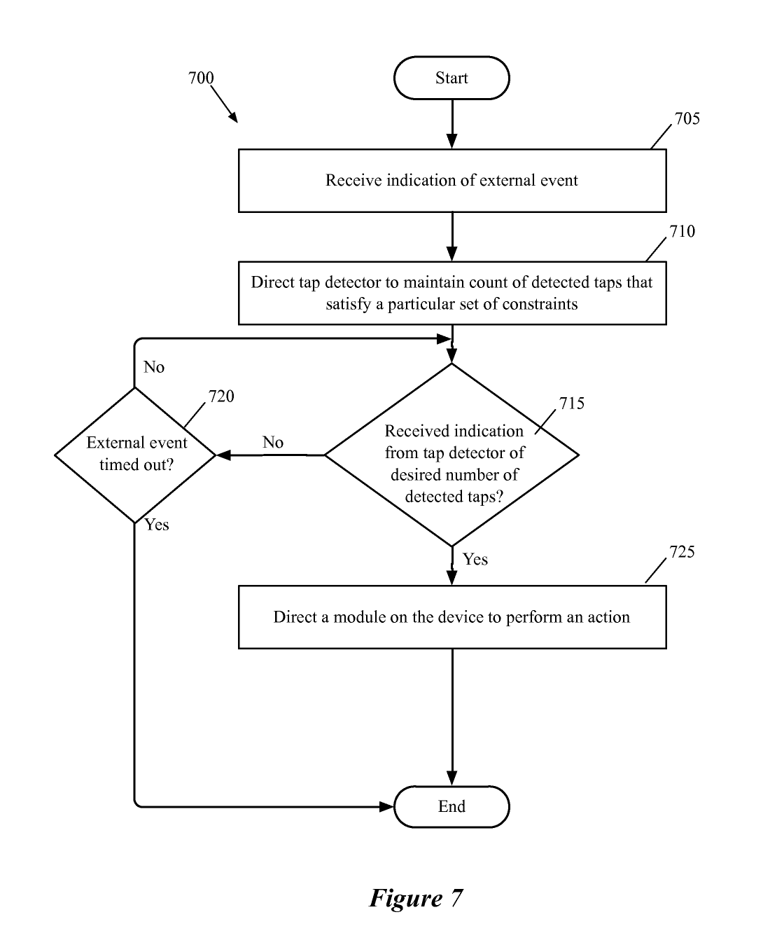

FIG. 7 conceptually illustrates a process 700 of some embodiments for initiating an operation based on the occurrence of an external event and the subsequent detection of a particular set of inputs. In some embodiments, the operation initiation processor 110 of some embodiments executes this process on the device on which the particular operation is to be initiated. As shown, the process initially receives (at 705) an indication of an external event. In some embodiments, the external event may be any event that is initiated outside of the process 700. Examples of such events include the triggering of an alarm, the receipt of a phone call, text message, e-mail message, or various other external events that generally require a response from a user (until the event is timed-out, etc.). Before the process 700, the operation initiation processor 110 of some embodiments registers with one or more modules for callbacks when various external events occur so that the processor can receive notification for the occurrence of particular external event(s).

After detecting an external event, the process directs (at 710) the tap detector 115 to maintain a count of the number of taps that it detects that meet a particular set of constraints. As mentioned above, the set of constraints includes one or more of the following constraints in some embodiments: overall timing constraint, relative timing constraint, start time constraint, device-orientation constraint, tap-location constraint, etc. Also, as mentioned above, the tap detector 115 of some embodiments monitors the output of one or more motion sensors (e.g., accelerometer, gyroscope, etc.) to determine whether the device has received a tap input, while the tap detector 115 of other embodiments receives notification of “tap” inputs from the OS framework of the device on which it executes.

At 715, the process determines whether it has received indication from the tap detector 115 that it has counted a number of detected taps that meet the particular set of constraints. If not, the process determines (at 720) whether the external event has timed out (e.g., the phone call has gone to voice mail, the alarm clock has rang for one minute and automatically shut off, etc.). If the external event has timed out, the process ends. Otherwise, the process returns to 715.

When the process 700 determines (at 715) that the tap detector 115 has notified the process that the detector has counted a number of detected taps that meet the particular set of constraints, the process directs (at 725) a module executing on the device to perform an action (i.e., operation). In some embodiments, the tap detector 115 not only notifies the process that it has detected a number of taps, but also informs the process of the exact number of taps and/or the specific constraints that were met for the detected number of taps. In these embodiments, the process uses the reported data to inform it of the operation that it has to generate. Also, in some embodiments, the particular module that is notified, and the operation that is performed, will be different based on (1) the external event and (2) the particular set of tap-inputs received. For example, when the external event is the receipt of a phone call, detecting two taps sends the phone call to voice mail, while detecting four taps answers the phone call. On the other hand, when the external event is the triggering of the alarm, detecting two taps snoozes the alarm, while detecting four taps turns off the alarm.

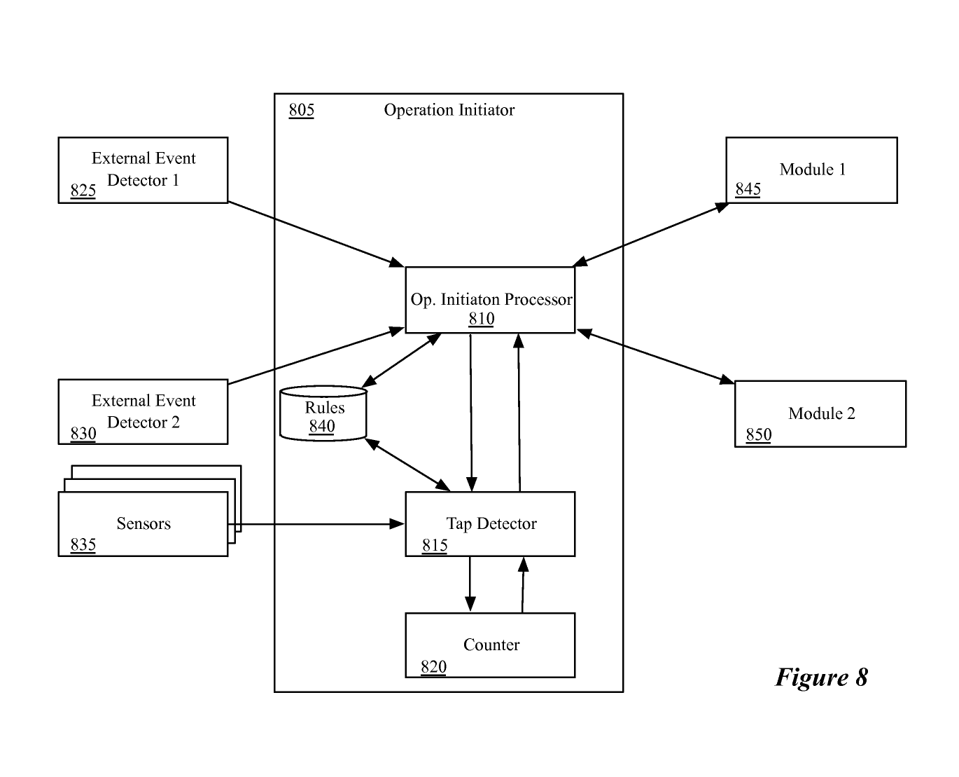

FIG. 8 illustrates how the operation initiator of some embodiments detects different types of tap inputs for different events in order to initiate different operations. Specifically, it illustrates an operation initiator 805 that is similar to the operation initiator 105 of FIG. 1. One difference with the operation initiator 105 is that the operation initiation processor 810 is illustrated to explicitly receive events from multiple event detectors 825 and 830 and to explicitly initiate the operation of multiple modules 845 and 850 after detecting the requisite number of tap inputs for different detected events.

Another difference is that the tap detector 815 is shown to explicitly receive output from more than one sensors 835, such as an accelerometer, a gyroscope, and/or other sensors for detecting movement of the device. Also, in FIG. 8, the operation initiator 805 is shown to have a rules storage 840 that stores several rules for specifying several sets of constraints to enforce for tap inputs that are sensed for different detected events. In some embodiments, each rule in the rules storage 840 specifies, a particular triggering external event, one set of tap inputs that may be received subsequent to the occurrence of the external event, a set of constraints that the detected set of tap inputs have to satisfy, and the corresponding operation to perform when a set of tap inputs is detected that meets the set of constraints specified for the set of tap inputs.

For example, in some embodiments, a rule may specify that an alarm notification should be snoozed, when the device detects two tap inputs within 0.5 second of each other but does not detect a third tap input within 0.5 seconds of the second tap input, while another rule specifies that an alarm notification should be turned off when the device detects four tap inputs, each within 0.5 seconds of another tap input. In other embodiments, the rules in the rules storage 840 may be a single rule that specifies numerous conditional statements for different triggering external events. In still other embodiments, the rules may be separated for different triggering events, or based on other dimensions.

Based on these rules, the operation initiation processor 810 and/or the tap detector 815 can determine whether a series of detected taps after the occurrence of a particular event meets the specified set of constraints for initiating a particular operation that is associated with the detected event. When a series of detected tap inputs do meet the specified set of constraints, the operation initiation processor 810 directs one of the modules 845 or 850 to perform the particular operation.

In order to identify motion-detected tap inputs, the operation initiator 805 of some embodiments uses output data from different motion sensors, or use different combinations of output data from different combinations of motion sensors. To determine whether particular operations should be initiated, the operation initiator 805 of some embodiments augments the output data from the motion sensor data with output data from non-motion sensor data (e.g., with output data from the touch-sensitive screen sensor or with output data from the location identification sensor(s)).

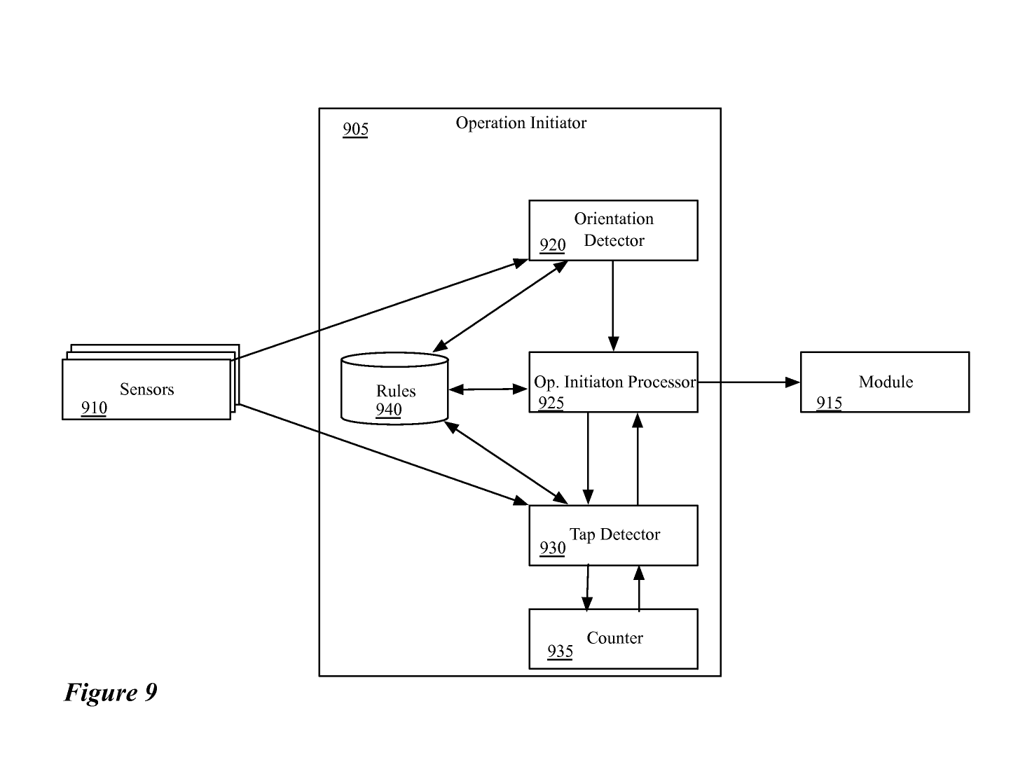

In some embodiments, the operation initiator of the device utilizes the device's sensor data in order to initiate an operation upon detecting that the device is (1) in a particular orientation and (2) has received a set of tap inputs while in the particular orientation. FIG. 9 illustrates one such operation initiator 905 of some embodiments. The operation initiator 905 is similar to the operation initiator 105 of FIG. 1 and the operation initiator 805 of FIG. 8, except that instead of using event detectors to trigger its operation, it uses an orientation detector 920 that detects a particular orientation of the device to trigger the operation of the operation initiator 905.

More specifically, the operation initiator 905 executes on a device (not shown) and directs a module 915 of the device to perform an operation when the initiator detects that the device is in a particular orientation and it detects that a particular number of motion-detected, tap inputs have been received while the device is in the particular orientation. In some embodiments, the initiator requires the tap inputs to meet a set of timing constraints (e.g., requires the taps to be received within 3 seconds of the device reaching its new orientation and within 2 seconds of each other) in order to validate the tap inputs and to initiate an operation on the device.

As shown in FIG. 9, the operation initiator 905 includes an orientation detector 920, an operation initiation processor 925, a rules storage 940, a tap detector 930 and a counter 935. The orientation detector 920 receives motion and/or orientation data from a set of one or more sensors 910. Based on this data, the orientation detector can detect when the device has been moved to a particular orientation for which the detector 920 needs to notify the operation initiation processor 925. In some embodiments, the rules storage 940 stores one or more rules that specify one or more particular orientations of the device for which the detector 920 needs to notify the processor 925. Accordingly, in some embodiments, the orientation detector periodically (1) monitors the sensor data to detect new orientations of the device, and (2) each time that it detects a new orientation, checks the rules storage to determine whether it needs to notify the processor 925 of the new orientation.

In different embodiments, the orientation detector 920 senses the device's orientation differently. For instance, in some embodiments, the orientation detector 920 receives raw sensor data from the set of sensors 910, and based on this data, identifies or computes the orientation of the device. The detector 920 uses different sets of sensors in different embodiments. For instance, in some embodiments, the device's sensors include accelerometers, gyroscopes, and/or other motion-sensing sensors that generate output that quantifies the motion of the device.

Accordingly, in different embodiments, the detector 920 relies on different combinations of these sensors to obtain data in order to ascertain the orientation of the device. In some embodiments, the detector 920 uses both accelerometer and gyroscope data to ascertain the orientation of the device, while in other embodiments the detector 920 uses only accelerometer data to ascertain the orientation of the device. Different sensors 910 provide different types of data regarding certain aspects of the device (e.g., movement, acceleration, rotation, etc.). In some embodiments, the data that is provided by different sensors can be used to obtain (e.g., identify or derive) the same orientation information but the data from different sensors might be useful to obtain data at different accuracy levels and/or at different delays in obtaining steady state data. For example, data from either a gyroscope or an accelerometer may be analyzed in order to determine the particular orientation of the device, but only the gyroscope data can provide direct information about the rotation of the device. Also, analyzing the combination of gyroscope and accelerometer data in some embodiments allows the detector 920 to determine the orientation with a higher level of accuracy than attainable using data from only one of the individual sensors.

In other embodiments, the orientation detector 920 does not rely on raw sensor data to detect the orientation of the device. For example, in some embodiments, the orientation detector relies on a function of the OS framework that monitors the raw sensor data, and for particular orientations (e.g., vertical, horizontal, side, etc.) of the device, generates an orientation signal that specifies a particular orientation (e.g., side) of the device. In other embodiments, one or more sensors of the device monitor their own raw sensor data, and for particular orientations of the device, generate orientation signals that specify particular orientations of the device. In either of these embodiments, the orientation detector 920 could pull the high-level orientation data (that specifies a particular orientation from a small set of possible orientations) from the OS framework or the sensor(s), or this data could be pushed to the orientation detector 920 from the OS framework or the sensor(s).

Once the orientation detector 920 determines that the device has been placed in a particular orientation (which may be one of several orientations that it is configured to monitor), the detector 920 notifies the operation initiation processor 925 of the new orientation. In response, the initiation processor 925 directs the tap detector 930 to determine whether the device will receive a particular number of tap inputs that meet a particular set of constraints. The operation initiator 905 enforces different sets of constraints in different embodiments. As in the embodiments described above by reference to FIGS. 1-8, the set of constraints can include time constraints (e.g., overall time constraints, relative time constraints, start time constraints, etc.), orientation constraints, and tap-location constraints. Also, for different orientations detected by the orientation detector 920, the operation initiator 905 can specify different constraints.

In some embodiments, these constraints are specified by the rules that are stored in the rules storage 940. Similar to rules that were described above by reference to FIG. 8, different rules in the rules storage 940 of FIG. 9 will specify different combinations of orientation and subsequent tap inputs for initiating different operations. In some embodiments, one set of rules in the rules storage 940 may specify (1) a particular orientation of the device, (2) a set of tap inputs that may be received while the device is in the particular orientation, (3) a set of constraints that the detected set of tap inputs have to satisfy, and (4) the corresponding operation to perform when a set of tap inputs is detected that meets the set of constraints specified for the set of tap inputs. For example, in some embodiments, a rule may specify that a camera application should be launched, when the device has moved to (or been rotated) and remained in a landscape orientation and the device receives three tap inputs with the first tap input received within three seconds of the device entering the particular orientation. Another rule may specify, for example, turning on a flashlight, when the device is held in a portrait orientation and receives two tap inputs within 0.5 seconds of each other and at no particular time after entering the particular orientation. For one orientation of the device, multiple rules can be specified for performing the same operation or different operations in some embodiments.

Like the orientation detector 920, the tap detector 930 of some embodiments communicates with the various sensors 910 in order to obtain raw sensor data to analyze in order to detect taps on the device. In some embodiments, the tap detector 930 communicates primarily with an accelerometer of the device in order to detect tap inputs, while in other embodiments it communicates with other different sensors (including the gyroscope). The tap detector 930 detects taps differently in other embodiments. For instance, like the tap detectors 115 and 815 of FIGS. 1 and 8, the tap detector 930 in some embodiments detects taps by receiving “tap” data from the device's OS framework, while in other embodiments detects taps by directly receiving high-level “tap” signals from one or more sensors.

Each time that the tap detector identifies a tap that meets one or more constraints (if any) that the detector is enforcing, it directs the counter 935 to increment its tap count. When the counter 935 has counted a specified number of taps, the tap detector notifies the initiation processor 925 that the detector 930 has detected the specified number of taps. Like the tap detectors 115 and 815 of FIGS. 1 and 8, the tap detector 930 in some embodiments ensures that the detected taps meet a specified set of constraints for the detected orientation and notifies the initiation processor 925 whenever it detects a set of taps that meet the specified set of constraints for the detected orientation. Alternatively, in other embodiments, the tap detector 930 simply notifies the initiation processor 925 of the detected taps (each time it receives a tap, or upon receiving a pre-specified number of taps), along with data regarding the taps (e.g., the time of receiving the tap) and the processor 925 is responsible for ensuring that the taps meet a specified set of constraints for the detected orientation. In yet other embodiments, the tap detector enforces one set of constraints on the detected taps, while the initiation processor 925 enforces another set of constraints on the detected taps. The tap detector 930 and the operation initiation processor 925 in some embodiments access the rules storage 940 to identify rules that specify requisite number of tap inputs, sets of constraints, and/or operations to initiate.

When the operation initiation processor 925 determines that a particular set of taps that meet a specified set of constraints have been received for a detected orientation of the device, the processor 925 directs a module 915 of the device to perform an operation. As in the example illustrated in FIG. 8, the operation initiator 905 of some embodiments directs the same or different modules to perform different operations based on the same or different number of detected taps that are received for the same or different detected orientations of the device.

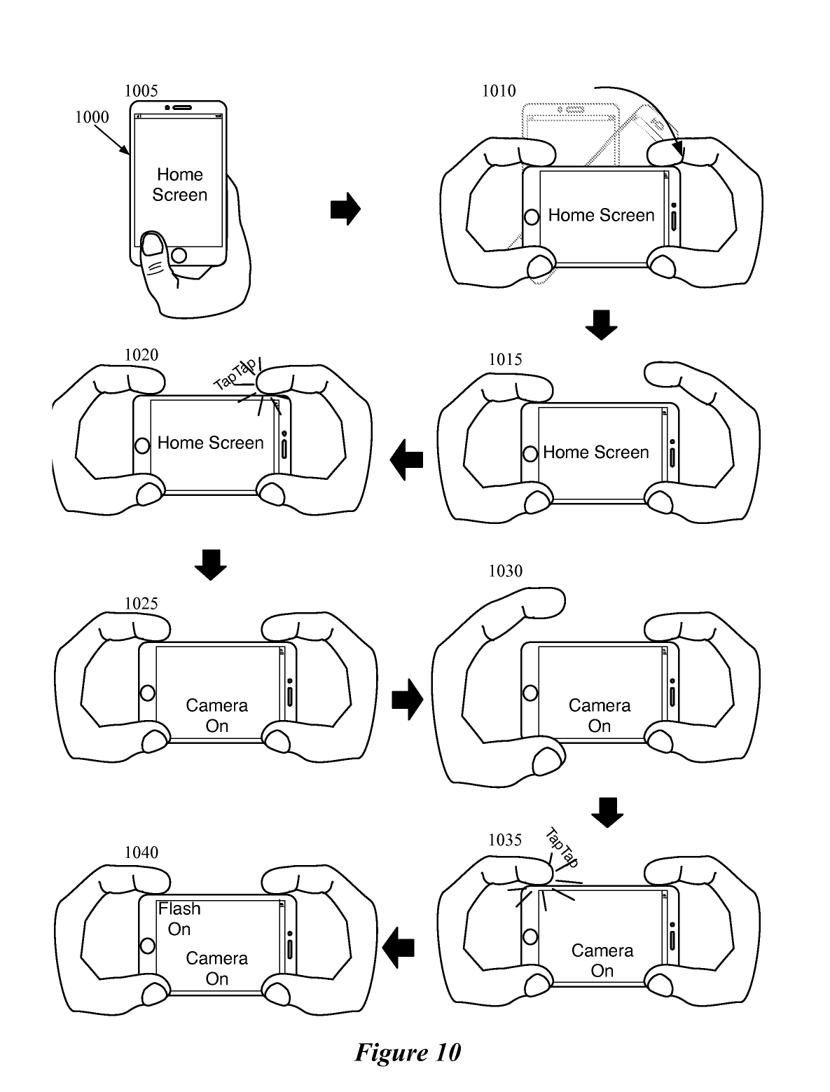

FIG. 10 illustrates an example of initiating an operation on a device 1000 upon detecting that the device is in a particular orientation and has received a set of tap inputs while in the particular orientation. In particular, this figure illustrates an example for launching a camera of the device 1000 in response to detecting the device in a side-way orientation (also called a landscape orientation) and detecting a set of tap inputs. This example is illustrated in eight stages 1005-1040 that correspond to the device (1) being rotated to a particular orientation, (2) receiving a first set of tap inputs to launch a camera application, and (3) receiving a second set of tap inputs to turn on a flash for the camera.

The first stage 1005 illustrates a user holding the mobile device upright in a portrait orientation. At this stage, the camera application has not launched and the device is displaying one of the pages (e.g., the home screen) that is presented by the operating system of the device. In this stage, the orientation detector 920 has determined that the device is in the portrait orientation (also called the upright orientation) based on the data collected from one or more sensors 910. As described above, the orientation detector 920 of some embodiments receives motion and/or orientation data from an accelerometer and a gyroscope. In some embodiments, the detector 920 uses both the accelerometer and gyroscope data to ascertain the orientation of the device, while in other embodiments the detector 920 uses only output data from either the accelerometer or gyroscope. Furthermore, these sensors continuously output data to the detector 920 such that it may immediately recognize a change in the orientation of the device.

Stage 1010 illustrates the user rotating the device 1000 from the upright orientation into a sideway orientation (also called a landscape orientation) by moving the device about 90° in the clockwise direction. In this stage 1020, the orientation detector 920 receives data from the sensors 910 that indicates the device has been rotated by about 90° in the clockwise direction. As described above, this data in some embodiments is raw sensor data that the orientation detector processes to determine the 90° clockwise rotation, while in other embodiments this data is higher-level orientation data from the OS framework or the sensor(s).

In order for a device to be considered “in” a particular orientation, these embodiments determine whether the device is within a certain range of values (e.g., between 80° and 110°) based on the device's sensor data. Thus, a user is not required to hold a device at, for example, exactly 90° in order to be in the landscape orientation, but may hold the device within the specified range of values and still be considered in the particular orientation. Also, for some or all of the operations initiated by the operation initiator 905, the orientation detector of some embodiments not only accounts for a particular orientation of the device at any given time, but accounts for how the device arrived at that particular orientation. For instance, for some or all of the operations initiated by the operation initiator 905, the orientation detector might differentiate a sideway orientation that was reached from a clockwise rotation of the device that initially started from an upright orientation, from a sideway orientation that was reached from a counterclockwise rotation of the device that initially started from an upright orientation.

Once the orientation detector 920 determines that the device has been placed in the particular orientation, and then determines that the particular orientation is one of the orientations for which the operation initiator 905 should monitor taps, the detector 920 notifies (during the second stage 910) the operation initiation processor 925 of the change in orientation. Again, in some embodiments, the orientation detector 920 does not only focus on the sideway orientation of the device during the second stage. Instead, in these embodiments, the orientation detector 920 notifies the processor of the change in orientation only after noting that the device rotated in the sideway orientation from the upright orientation, or rotated into this upright orientation through a 90° clockwise orientation. Upon receiving the notification from the orientation detector, the processor 925 directs the tap detector 930 to determine whether a certain number of taps are made on the device while the device is in the particular orientation.

Stages 1015-1020 illustrate the device receiving a set of tap inputs that causes the device to launch a camera application. In particular, stages 1015 illustrates the user lifting his right index finger from an edge of the device and stage 1020 illustrates the user applying two taps (illustrated as “tap tap”) on the right edge of the device. As described above, the particular location of the tap inputs may also be used to initiate different operations. For example, the device will execute a different operation based on whether the tap is on the left edge of the device versus the right edge of the device.

Stage 1025 illustrates the device launching a camera application after the detected two taps on the right-edge of the device in stage 1020. In this particular stage, the tap detector 930 of some embodiments has determined that it has received two taps that satisfy a set of timing constraints. In other embodiments, the tap detector at this stage has determined that it has received two taps that satisfy other sets of constraints or other combinations of sets of constrains, such as timing constraints, location constraints (e.g., the taps were on the right edge of the device), et.

When the tap detector 930 determines that the taps satisfy the required set(s) of constraints, the tap detector 930 notifies the operation initiation processor 925 of the receipt of the two taps. In response, the processor 925 directs the module 915 to launch the camera application on the device, as shown in stage 1025.

Stages 1030-1040 of FIG. 10 further illustrate the tap-location constraints of some embodiments. In particular, these stages illustrate the user turning on a flash on the camera by tapping the left-edge of the device. In particular, stage 1030 illustrates the user lifting his left index finger and stage 1035 illustrates the user applying two taps on the left-edge of the device (illustrated as “tap tap”). In this stage, the tap detector 930, using information from sensors 910, determines that the two taps have been received within the left edge of the device while the device is in the landscape orientation and with the camera application turned on. In some embodiments, the tap detector also accounts for the fact that the camera application has been launched at this stage. Accordingly, at stage 1035, the tap detector 930 notifies the operation initiation processor 925 of the receipt of the two taps on the left edge of the device. In response, the processor 925, based on the rules defined in rules storage 940, directs the flash module to turn on a flash of the camera, as illustrated in stage 1040.

FIG. 10 illustrates the device requiring a set of location constraints (e.g., tap on left edge vs. right edge) that need to be satisfied by different sets of tap inputs in order to launch a camera and a subsequent flash of the device. In some embodiments, the device will launch the camera after detecting a set of taps at any location of the device while the device is in a landscape orientation. Furthermore, a subsequent set of tap inputs received at any location of the device after the camera has been launched will turn on the flash. Thus different embodiments may specify different combinations of constraints for initiating an operation while a device is in a particular orientation.

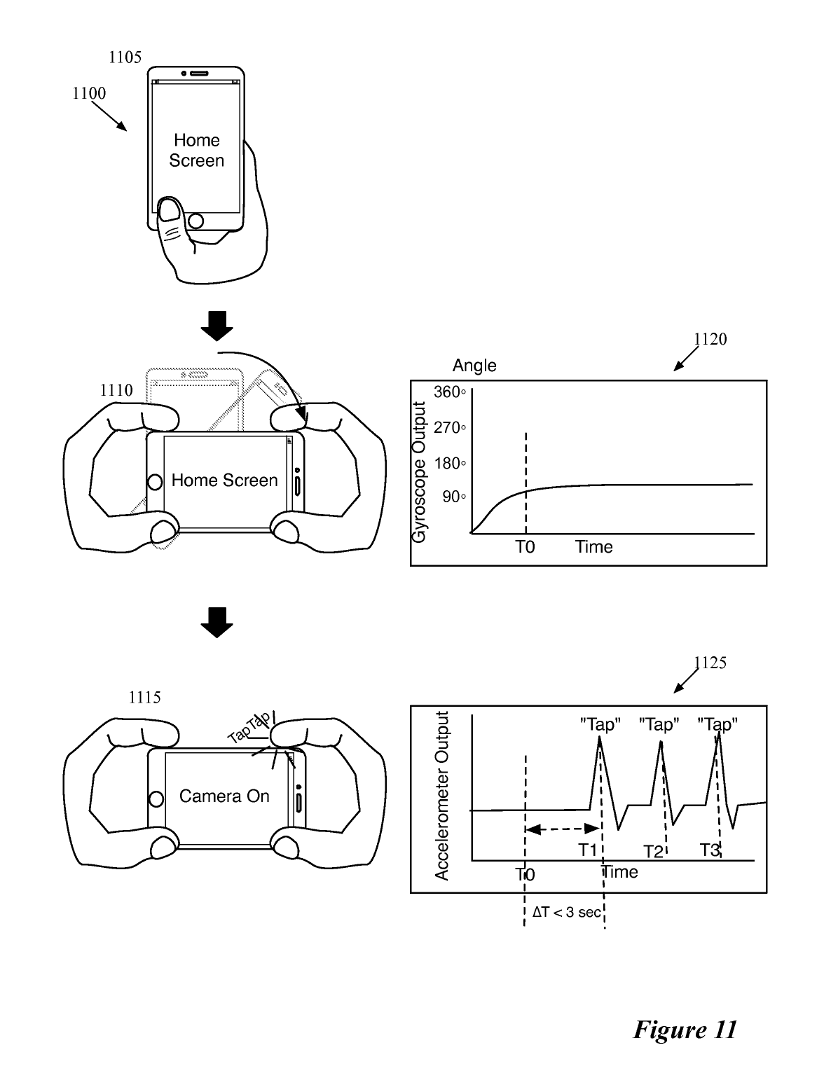

Furthermore, although not a requirement in FIG. 10, the device of some embodiments specifies a certain start time constraint that specifies a time period by which a tap input must be received after the device has been moved into a particular orientation. For example, the start time constraint in some embodiments requires that a first tap in a set of tap inputs be received within three seconds after the device has entered the landscape orientation. FIG. 11 illustrates an example of launching a camera application on a device 1100 that specifies a start time constraint requiring a set of tap inputs be received within a particular time period of the device entering a landscape orientation. This figure illustrates this example in three stages 1105-1115 that correspond to a device being rotated into a landscape orientation, the receipt of three tap inputs on a side of the device with the first tap input received within 3 seconds of the device entering the landscape orientation, and the launching of a camera on the device.

Furthermore, each stage 1105-1115 illustrates a graph of the output data 1120 and 1125 from different sensors of the device. In particular, a first graph 1120 illustrates sensor data output from a gyroscope of the device with the x-axis representing time and the y-axis representing the particular orientation, represented in degrees, of the device. A second graph 1125 illustrates sensor data output from an accelerometer of the device with the x-axis representing time and the y-axis representing motion data detected by the accelerometer. Note that the time represented along the x-axis in each graph 1120 and 1125 corresponds to a same time period for both graphs (i.e., time “T1” corresponds to the same actual time for both the gyroscope and accelerometer).

Stages 1105-1110 illustrate a user rotating a device into a landscape orientation (or within a certain range that corresponds to the landscape orientation). As illustrated by the graph of the gyroscope 1120, the device has been rotated from a 0° (degree) angle (or within a close range of) 0° and rotated into (or within a range of) a 90° angle (i.e., landscape orientation) at a time T0 and is being held at this particular orientation. In some embodiments, the sensors continuously output data to the orientation detector 920 on the device in order to enable the detector 920 to detect the particular instant in time that the device enters a particular orientation. For example, data from both the device's accelerometer and gyroscope may be analyzed in order to determine the moment that the device has entered a particular orientation (or within a range of the orientation).

Furthermore, as describe above, different sensors are able to output data at different accuracy levels and/or at different delays in time. As such, the orientation detector 920 in some embodiments may analyze combinations of data from different sensors in order to determine the movement and orientation of the device at a particular time. However, for the example illustrated in FIG. 11, the orientation detector in some embodiments primarily relies on the gyroscope output to determine the transition in the orientation of the device because the gyroscope is faster at providing this data.

As illustrated by the gyroscope graph 1120 of FIG. 11, the orientation detector 920 can determine that the device has moved into the landscape orientation at a time “T0” labeled along the x-axis of both graphs 1120 and 1125. Based on the start time constraint illustrated in this example, the user now has three seconds from time T0 to input a first tap (in a total of three taps) on the device in order for the device to launch the camera.

The third stage 1115 illustrates the device receiving three taps on a side of the device. It also shows the accelerometer graph 1125 having three spikes along the graph that represent the accelerometer output data that is generated for these three taps (T1, T2, T3) at different times, with the first tap T1 received at time T1. The graph 1125 also illustrates that time of the first tap T1 is also less than 3 seconds after time T0, (time T0 corresponding to the time the device was moved into the landscape orientation) which satisfies the start time constraint that a tap input be received within 3 seconds of the device moving into the landscape orientation. Thus in this example, the tap detector 930 has detected three taps with the first tap detected within 3 seconds of the device entering a landscape orientation, and therefore the tap detector notified the operation initiation processor 925 of the three taps. As described above, in some embodiments, the tap detector 930 is responsible for ensuring that the detected taps meet the specified set of constraints while in other embodiments, the tap detector 930 simply notifies the initiation processor 925 of the detected taps (each time it receives a tap, etc.) along with data regarding the taps (e.g., the time of received the tap) and the processor 925 is responsible for ensuring that the taps meet the specified set of constraints, including the 3 second start time constraint. Furthermore, as described above, in other embodiments, the tap detector 930 enforces one set of constraints while the initiation processor 925 enforces another set of constraints on the detected taps.

Based on the three taps satisfying the set of constraints, including the 3 second start time constraint, the processor 925 directs the device to launch a camera application on the device. Other embodiments do not enforce a start time constraint and thus the three tap inputs may be detected at any time after the device is in (or within a particular range) of the landscape orientation.

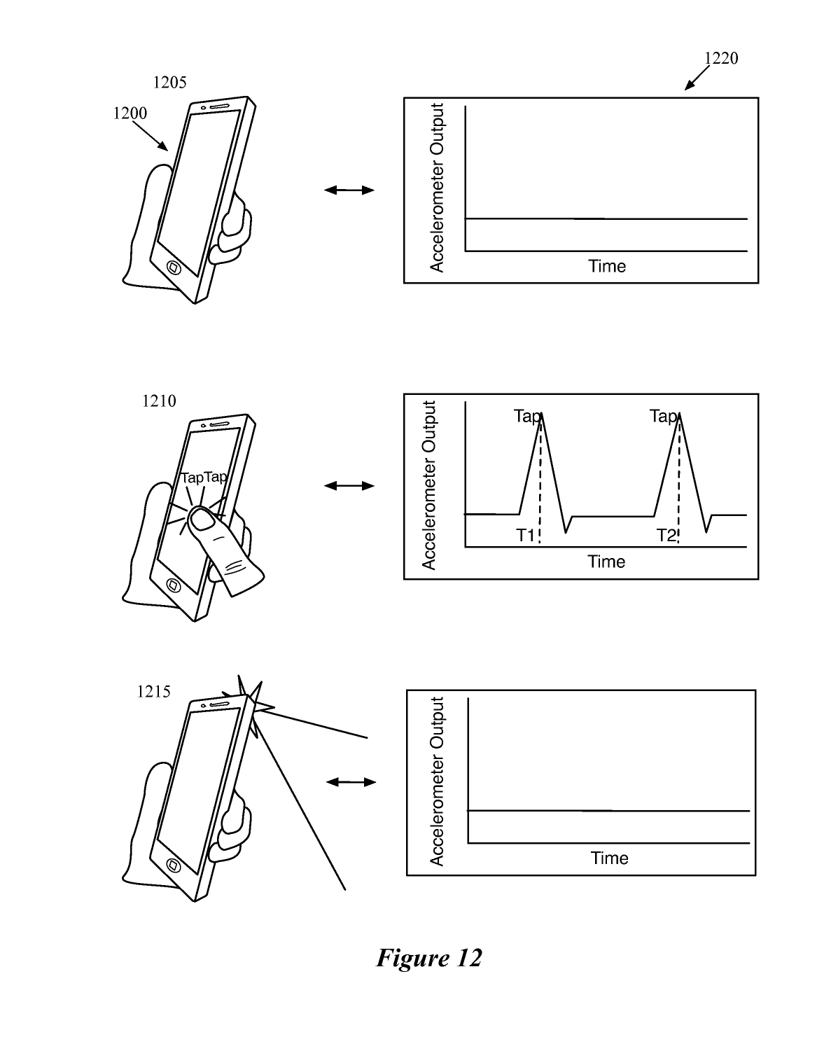

Different combinations of orientation and motion-detected tap inputs may initiate other operations on the device. FIG. 12 illustrates an example of one such other operation, which in this example is the turning on of a flashlight on a device. In this example, the flashlight is turned on based on the device (1) being in a particular orientation and (2) receiving a set of tap inputs while in the particular orientation. In particular, this figure illustrates in three stages 1205-1215 an example of the device 1200 being held upright at a slightly downward angle (e.g., with a 20°-90°) and receiving a set of tap inputs to turn on a flashlight of the device. Each stage also illustrates an accelerometer graph 1220 that illustrates the output of the accelerometer of the device at different times, with the x-axis representing time and the y-axis representing motion data detected by the accelerometer.

Stage 1205 illustrates a user holding the device upright at a slightly downward angle (e.g.,) 20°. At this particular stage, the accelerometer graph 1220 illustrates a flat line which indicates that the device has not yet detected any tap inputs. Also, at this stage, the orientation detector has noted the device is in one of the requisite orientations that it should monitor, and hence has notified the operation initiation processor of the device's particular orientation. In turn, this processor has notified the tap detector to start examining the sensor output data in order to check for taps.

Stage 1210 illustrates the user tapping twice on a screen of the device (illustrated as “tap tap”). It also shows the accelerometer graph 1220 having two spikes along the graph that represent the accelerometer output data that is generated for these two taps at different times T1 and T2. Based on this set of tap inputs and the device being held in the particular portrait orientation, the device initiates a flashlight of the device, as illustrated by stage 1215. Thus unlike the example in FIG. 11, where the device launched a camera after receiving a certain number of taps, because the device is now in the angled portrait orientation, tapping the device has caused a flashlight to be turned on. In this example, unlike FIG. 11, the operation initiator 905 in some embodiments does not enforce a particular time period after the device has entered the portrait orientation by which the user must apply the tap inputs in order to launch the flashlight. In other embodiments, the operation initiator might enforce such a constraint.

Many different operations may be defined based on different combinations of orientation and corresponding set of inputs of the device. Furthermore, some embodiments may utilize other information from the various sensors, including the movement (rotation, shaking, etc.) of the device in order to initiate different operations. For example, some embodiments may analyze how the device is moving (e.g., rotating, shaking, etc.) in order to initiate different operations.

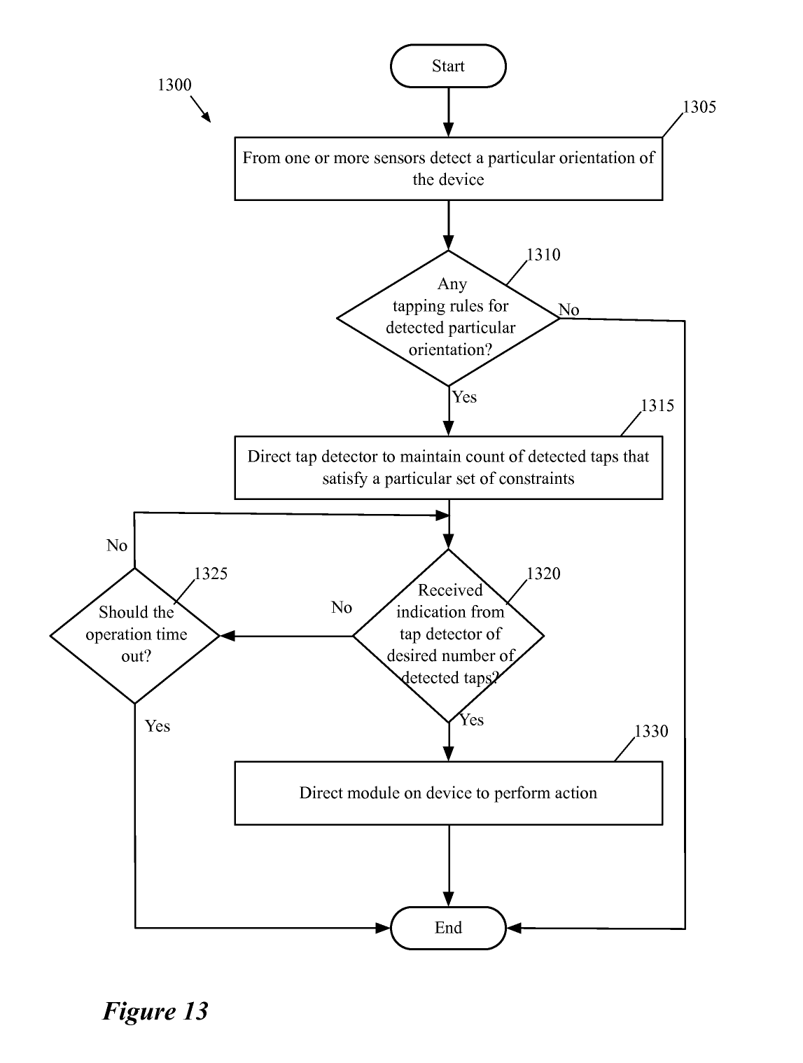

FIG. 13 conceptually illustrates a process 1300 of some embodiments for initiating an operation based on a detected orientation of a device and the subsequent detection of a particular set of inputs. In some embodiments, the operation initiation processor 925 of FIG. 9 of some embodiments executes this process on the device on which the particular operation is to be initiated. As shown, the process initially detects (at 1305), from one or more sensors of the device, that the device is in a particular orientation. The orientation of the device can be ascertained using data from a combination of sensors that includes the device's gyroscope, accelerometer, and/or other sensors that generate output based on the movement of or physical interactions with the device. Furthermore, these sensors can provide output data regarding whether (and how) the device has been moved (i.e., rotated) into the current orientation of the device. Some embodiments may augment data from a combination of sensors in order to obtain a greater level of accuracy regarding the orientation of the device.

Based on the particular orientation and/or movement of the device to the orientation, the process determines (at 1310) whether there are any tapping rules for the detected orientation. If there are no tapping rules, the process ends. If there are tapping rules, the process transitions to 1315. Given that the orientation detector in some embodiments initiates the process 1300 when it informs the processor 925 that the device has been placed in a particular orientation for which there exists at least one set of tapping rules, the process 1300 does not perform the check 1310 in some embodiments.

At 1315, the process directs the tap detector 930 to maintain a count of the number of taps that it detects that meet a particular set of constraints. As mentioned above, the set of constraints include one or more of the following constraints in some embodiments, overall timing constraint, relative timing constraint, start time constraint, device orientation constraint, tap-location constraint, etc. Furthermore, in some embodiments, the tap detector 930 communicates with the same sensors used to detect the orientation in order to detect and count the motion-detected tap inputs. In some embodiments, the tap detector 930 only communicates with a subset of the sensors used to detect the orientation (e.g., only the accelerometer), while in other embodiments, the tap detector 930 communicates with a different set of sensors than those used to determine the orientation of the device.

At 1320, the process determines whether it has received indication from the tap detector 930 that it has counted a number of detected taps that meet the particular set of constraints. If not, the process determines (at 1325) whether the operation should time out. In some embodiments, the process determines that the operations should time out when the device is no longer in the same orientation (e.g., the device is still in a landscape orientation) that caused the process to be launched. In some embodiments, the subsequent tap inputs must be received while the device has a particular orientation. For example, when a user rotates the device into a landscape orientation, the device will only launch a camera application if it detects a certain set of tap inputs while the device is still in the landscape orientation. Also, in some embodiments, the process determines that the operation should time out if the requisite number of taps have not been received or initiated within a particular timing constraint as mentioned above.

When the process determines (at 1325) that the process 1300 should time out, the process ends. Otherwise, the process returns to 1320. When the process determines that (at 1320) that the tap detector 930 has notified the process that the detector has counted a number of detected taps that meet the particular set of constraints, the process directs (at 1330) a module executing on the device to perform an action (i.e., operation). The particular module that is called to initiate the operation will be different based on the particular set of tap inputs detected and the orientation of the device. For example, if the device detects two taps after the device has been rotated into a landscape orientation, the device may launch the camera application whereas if the device detects only one tap (or three taps, etc.) the device may initiate a different operation (or no operation at all). Likewise, if the device detects two taps while the device is in a portrait orientation, the device may turn on a flashlight on the device.

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

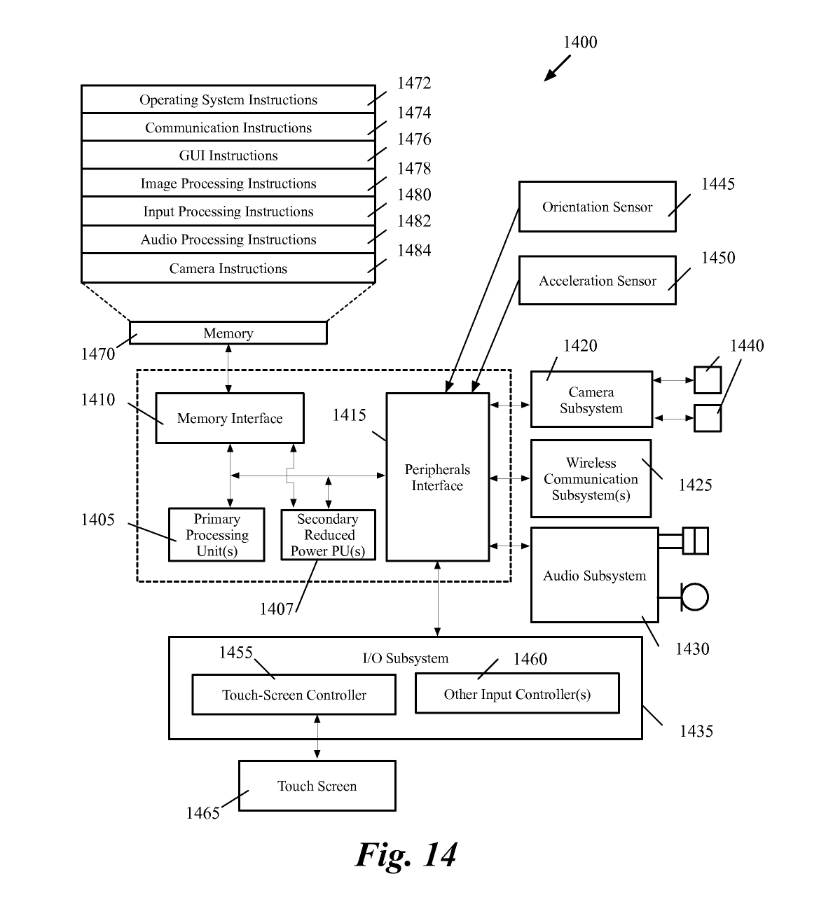

FIG. 14 is an example of an architecture 1400 of a mobile computing device. Examples of mobile computing devices include smartphones, tablets, laptops, etc. As shown, the mobile computing device 1400 includes one or more primary processing units 1405 and secondary (reduced power) processing units 1407, a memory interface 1410 and a peripherals interface 1415.

The peripherals interface 1415 is coupled to various sensors and subsystems, including a camera subsystem 1420, a wireless communication subsystem(s) 1425, an audio subsystem 1430, an I/O subsystem 1435, etc. The peripherals interface 1415 enables communication between the primary processing units 1405, secondary (reduced power) processing units 1407 and various peripherals. For example, an orientation sensor 1445 (e.g., a gyroscope) and an acceleration sensor 1450 (e.g., an accelerometer) is coupled to the peripherals interface 1415 to facilitate orientation and acceleration functions. Furthermore, the secondary (reduced power) processing units 1407 may collect, process and store sensor data from the orientation sensor 1445 and acceleration sensor 1450 while reducing the power consumption of the device. In some embodiments, the secondary processing units 1407 process data when the device is both asleep and powered on.

The camera subsystem 1420 is coupled to one or more optical sensors 1440 (e.g., a charged coupled device (CCD) optical sensor, a complementary metal-oxide-semiconductor (CMOS) optical sensor, etc.). The camera subsystem 1420 coupled with the optical sensors 1440 facilitates camera functions, such as image and/or video data capturing. The wireless communication subsystem 1425 serves to facilitate communication functions. In some embodiments, the wireless communication subsystem 1425 includes radio frequency receivers and transmitters, and optical receivers and transmitters (not shown in FIG. 14). These receivers and transmitters of some embodiments are implemented to operate over one or more communication networks such as a GSM network, a Wi-Fi network, a Bluetooth network, etc. The audio subsystem 1430 is coupled to a speaker to output audio (e.g., to output voice navigation instructions). Additionally, the audio subsystem 1430 is coupled to a microphone to facilitate voice-enabled functions, such as voice recognition (e.g., for searching), digital recording, etc.

The I/O subsystem 1435 involves the transfer between input/output peripheral devices, such as a display, a touch screen, etc., and the data bus of the processing units 1405 and 1407 through the peripherals interface 1415. The I/O subsystem 1435 includes a touch-screen controller 1455 and other input controllers 1460 to facilitate the transfer between input/output peripheral devices and the data bus of the primary processing units 1405 and secondary processing units 1407. As shown, the touch-screen controller 1455 is coupled to a touch screen 1465. The touch-screen controller 1455 detects contact and movement on the touch screen 1465 using any of multiple touch sensitivity technologies. The other input controllers 1460 are coupled to other input/control devices, such as one or more buttons. Some embodiments include a near-touch sensitive screen and a corresponding controller that can detect near-touch interactions instead of or in addition to touch interactions.

The memory interface 1410 is coupled to memory 1470. In some embodiments, the memory 1470 includes volatile memory (e.g., high-speed random access memory), non-volatile memory (e.g., flash memory), a combination of volatile and non-volatile memory, and/or any other type of memory. As illustrated in FIG. 14, the memory 1470 stores an operating system (OS) 1472. The OS 1472 includes instructions for handling basic system services and for performing hardware dependent tasks.

The memory 1470 also includes communication instructions 1474 to facilitate communicating with one or more additional devices; graphical user interface instructions 1476 to facilitate graphic user interface processing; image processing instructions 1478 to facilitate image-related processing and functions; input processing instructions 1480 to facilitate input-related (e.g., touch input) processes and functions; audio processing instructions 1482 to facilitate audio-related processes and functions; and camera instructions 1484 to facilitate camera-related processes and functions. The instructions described above are merely exemplary and the memory 1470 includes additional and/or other instructions in some embodiments. For instance, the memory for a smartphone may include phone instructions to facilitate phone-related processes and functions. Additionally, the memory may include instructions for a mapping and navigation application as well as other applications. The above-identified instructions need not be implemented as separate software programs or modules. Various functions of the mobile computing device can be implemented in hardware and/or in software, including in one or more signal processing and/or application specific integrated circuits.

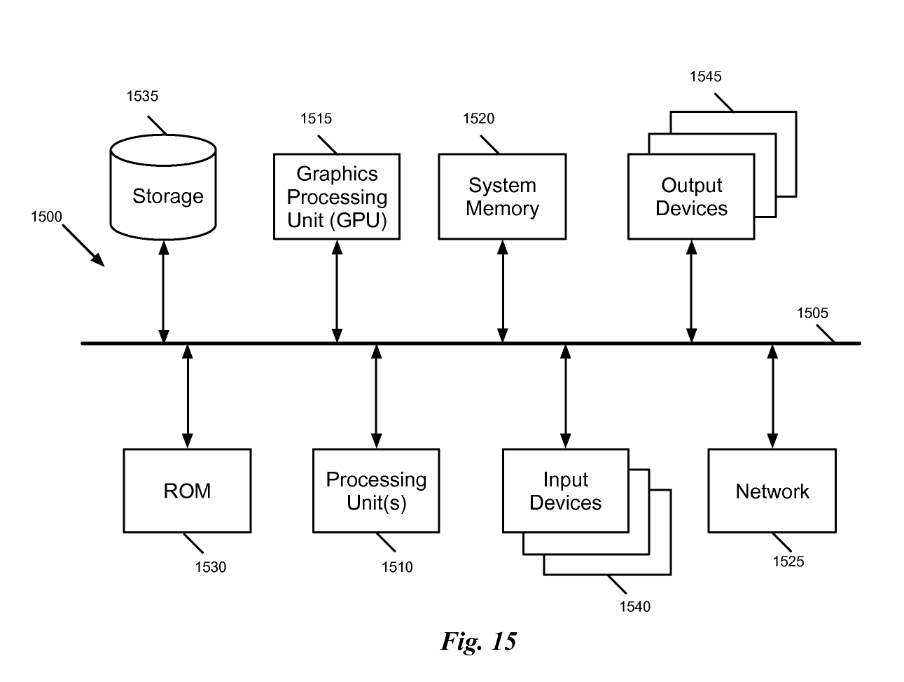

While the components illustrated in FIG. 14 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 14 may be split into two or more integrated circuits. FIG. 15 conceptually illustrates another example of an electronic system 1500 with which some embodiments of the invention are implemented. The electronic system 1500 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 1500 includes a bus 1505, processing unit(s) 1510, a graphics processing unit (GPU) 1515, a system memory 1520, a network 1525, a read-only memory 1530, a permanent storage device 1535, input devices 1540, and output devices 1545.

The bus 1505 collectively represents all system, peripheral, and chipset buses that communicatively connect the numerous internal devices of the electronic system 1500. For instance, the bus 1505 communicatively connects the processing unit(s) 1510 with the read-only memory 1530, the GPU 1515, the system memory 1520, and the permanent storage device 1535.

From these various memory units, the processing unit(s) 1510 retrieves instructions to execute and data to process in order to execute the processes of the invention. The processing unit(s) may be a single processor or a multi-core processor in different embodiments. Some instructions are passed to and executed by the GPU 1515. The GPU 1515 can offload various computations or complement the image processing provided by the processing unit(s) 1510. In some embodiments, such functionality can be provided using Corelmage's kernel shading language.

The read-only-memory (ROM) 1530 stores static data and instructions that are needed by the processing unit(s) 1510 and other modules of the electronic system. The permanent storage device 1535, on the other hand, is a read-and-write memory device. This device is a non-volatile memory unit that stores instructions and data even when the electronic system 1500 is off. Some embodiments of the invention use a mass-storage device (such as a magnetic or optical disk and its corresponding disk drive, integrated flash memory) as the permanent storage device 1535.

Other embodiments use a removable storage device (such as a floppy disk, flash memory device, etc., and its corresponding drive) as the permanent storage device. Like the permanent storage device 1535, the system memory 1520 is a read-and-write memory device. However, unlike storage device 1535, the system memory 1520 is a volatile read-and-write memory, such a random access memory. The system memory 1520 stores some of the instructions and data that the processor needs at runtime. In some embodiments, the invention's processes are stored in the system memory 1520, the permanent storage device 1535, and/or the read-only memory 1530. For example, the various memory units include instructions for processing multimedia clips in accordance with some embodiments. From these various memory units, the processing unit(s) 1510 retrieves instructions to execute and data to process in order to execute the processes of some embodiments.

The bus 1505 also connects to the input and output devices 1540 and 1545. The input devices 1540 enable the user to communicate information and select commands to the electronic system. The input devices 1540 include alphanumeric keyboards and pointing devices (also called “cursor control devices”), cameras (e.g., webcams), microphones or similar devices for receiving voice commands, etc. The output devices 1545 display images generated by the electronic system or otherwise output data. The output devices 1545 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 15, bus 1505 also couples electronic system 1500 to a network 1525 through a network adapter (not shown). In this manner, the computer can be a part of a network of computers (such as a local area network (“LAN”), a wide area network (“WAN”), or an Intranet), or a network of networks, such as the Internet. Any or all components of electronic system 1500 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. For instance, in many of the examples described above, the tap inputs are received on the same device on which the external event or particular orientation is detected and on which the operation in response to the tap input is performed. This might not be the case for all embodiments. In some embodiments, the tap inputs are received on a different device than the device on which the external event or particular orientation is detected or on which the operation in response to the tap input is performed.

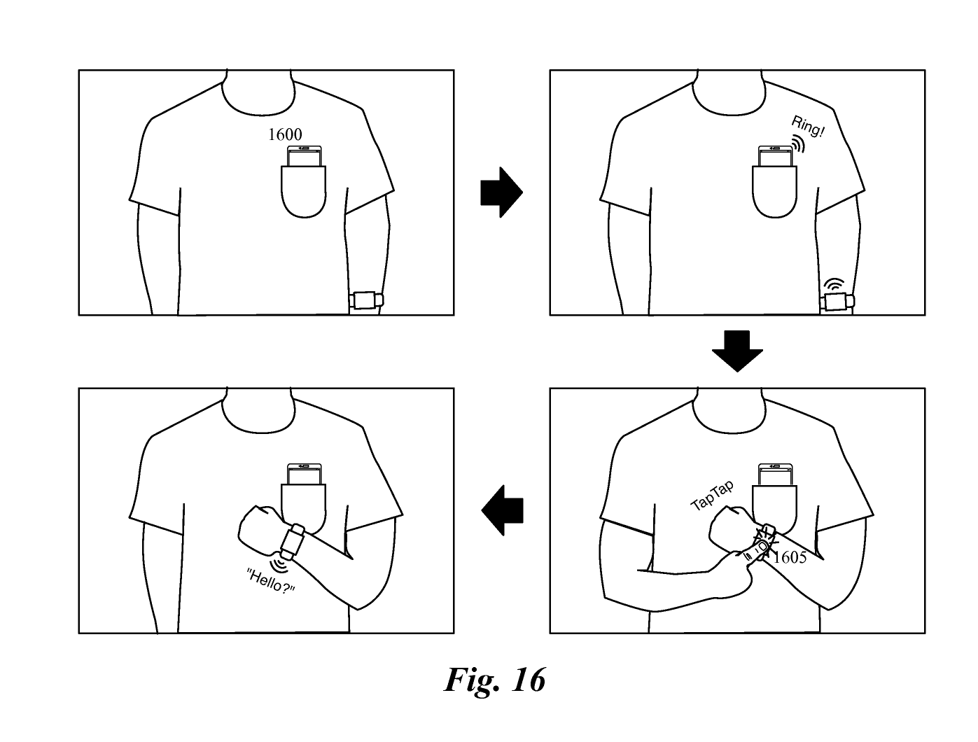

FIG. 16 is an example of detecting an external event on a first device, receiving tap inputs on a second device, and performing operations on the first device in response to the tap inputs. In this example, the first device is a smartphone 1600, while the second device is a watch 1605 that communicatively couple to the first device (e.g., through a Bluetooth connection). Also, in this example, the external event is reception of a phone call on the phone 1600. In response to this phone call, a tap detector on the watch 1605 is notified to detect taps, by an operation initiation processor on the phone 1600.

The watch's tap detector uses one or more motion sensors of the watch to detect multiple tap inputs (e.g., two taps) within a short duration of being notified of the external event by the phone. After detecting these taps, the watch's tap detector notifies the phone's operation initiator, which in turn directs a module on the phone to answer the received call.

Even through the example in FIG. 16 relates to receiving an external event, one of ordinary skill in the art will realize that the tap detector of the watch could be directed to detect taps when the phone is placed in a particular orientation. For instance, in some embodiments, a user can place the phone upright or sideways on one of its sides, walk away from the phone, and then tap on his watch in order to direct the phone to take a picture or a video of the user, a group of people including the user, or a scene.

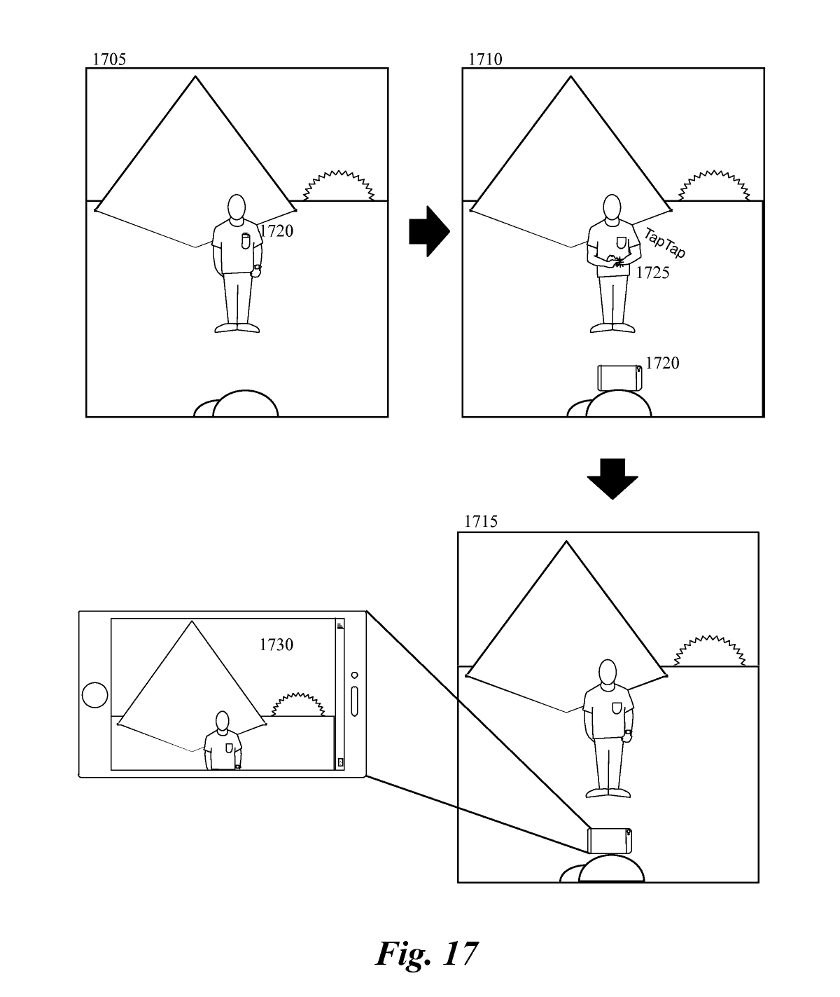

FIG. 17 illustrates one such example. Specifically, it presents (1) a first stage 1705 that illustrates a smartphone 1720 in the shirt pocket of a user, (2) a second stage 1710 that illustrates the smartphone 1720 placed on a surface in front of the user and the user tapping on a watch 1725 that communicatively couples to the phone (e.g., through Bluetooth), and (3) a third stage 1715 that illustrates a picture 1730 that the phone 1720 has taken in response to the detected tap inputs. The taps are detected in some embodiments by an accelerometer of the watch. Also, in some embodiments, the user can get a preview of the photo on the watch, because the phone in these embodiments sends to the watch a preview of the image that it is capturing through the connection (e.g., Bluetooth connection) between the phone and the watch.

One of ordinary skill in the art will realize that in some embodiments the external event or particular orientation can be detected on a first device, the taps can be detected on a second device, and the operation can be performed on a third device. Many of the above-described figures illustrate various touch gestures (e.g., taps, double taps, swipe gestures, press and hold gestures, etc.). However, many of the illustrated operations could be performed via different touch gestures (e.g., a swipe instead of a tap, etc.) or by non-touch input (e.g., using a cursor controller, a keyboard, a touchpad/trackpad, a near-touch sensitive screen, etc.). In addition, a number of the figures conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. One of ordinary skill in the art would understand that the invention is not to be limited by the foregoing illustrative details, but rather is to be defined by the appended claims.

1. A method of operating a mobile device, the method comprising:
detecting occurrence of an event on the device;
after occurrence of the event, using a set of motion sensors to detect a plurality of motion-detected tap inputs that meet a set of constraints; and
performing a particular operation in response to the detected plurality of motion-detected tap inputs.

2. The method of claim 1, wherein the set of constraints comprises a timing constraint that specifies a time period for detecting one or more of the tap inputs.

3. The method of claim 1, wherein the set of constraints comprises an orientation constraint that specifies an orientation that the device must have while detecting the plurality of motion-detected tap inputs.

4. The method of claim 1, wherein the set of constraints comprises a tap-location constraint that specifies a location on the device at which the plurality of motion-detected tap inputs must be received.

5. The method of claim 1, wherein the plurality of motion-detected tap inputs are indicative of a request for the particular operation.

6. The method of claim 1, wherein the particular operation is a subsequent second operation, wherein detecting occurrence of the event further comprises detecting that a module on the device has been directed to perform an initial first operation, wherein the second operation is related to the first operation.

7. The method of claim 1, wherein the set of motion sensors comprises at least one of an accelerometer and a gyroscope.

8. The method of claim 1, wherein when the plurality of motion-detected tap inputs equals a first number of tap inputs, the particular operation is a first operation; and when the plurality of motion-detected tap inputs equals a second number of tap inputs, the particular operation is a second operation.

9. A non-transitory machine readable medium storing a program for execution by at least one processing unit of a mobile device comprising a plurality of sensors, the program comprising sets of instructions for:
detecting occurrence of an event on the device;
after occurrence of the event, using a set of motion sensors to detect a plurality of motion-detected tap inputs that meet a set of constraints; and
performing a particular operation in response to the detected plurality of motion-detected tap inputs.

10. The non-transitory machine readable medium of claim 9, wherein the set of constraints comprises a timing constraint that specifies a time period for detecting one or more of the tap inputs.

11. The non-transitory machine readable medium of claim 10, wherein the time period is a period during which a first tap input has to be detected after the detection of the event.

12. The non-transitory machine readable medium of claim 10, wherein the time period is a period during which all the tap inputs have to be detected.

13. The non-transitory machine readable medium of claim 10, wherein the time period is a relative time period that specifies a maximum delay that may exist between two successive tap inputs for the two successive tap inputs to be counted as being part of the same detected plurality of tap inputs.

14-19. (canceled)

20. The non-transitory machine readable medium of claim 9, wherein when the plurality of motion-detected tap inputs equals a first number of tap inputs, the particular operation is a first operation; and when the plurality of motion-detected tap inputs equals a second number of tap inputs, the particular operation is a second operation.

21. The non-transitory machine readable medium of claim 20, wherein the event is a phone call, the first operation is answering the phone call, and the second operation is directing the phone call to voicemail.

22. The non-transitory machine readable medium of claim 20, wherein the event is a reception of an alarm notification, the first operation is snoozing the alarm notification, and the second operation is turning off the alarm notification.

23. A device comprising:
a set of processing units;
a machine readable storage storing a program for execution by at least one of the processing units, the program comprising sets of instructions for:
detecting occurrence of an event on the device;
after occurrence of the event, using a set of motion sensors to detect a plurality of motion-detected tap inputs that meet a set of constraints; and
performing a particular operation in response to the detected plurality of motion-detected tap inputs.

24. The device of claim 23, wherein the set of constraints comprises a timing constraint that specifies a time period for detecting one or more of the tap inputs.

25. The device of claim 23, wherein the set of constraints comprises an orientation constraint that specifies an orientation that the device must have while detecting the plurality of motion-detected tap inputs.

26. A method of operating a mobile device, the method comprising:
based on a first set of motion sensors, detecting that the mobile device has a particular orientation;
while the mobile device has the particular orientation, using a second set of motion sensors to detect a plurality of motion-detected tap inputs that meet a set of constraints; and
performing a particular operation on the mobile device in response to the detected plurality of motion detected tap inputs.

27-32. (canceled)

33. A method of operating a mobile device comprising an accelerometer and a gyroscope, the method comprising:
based on a set of gyroscope output signals, detecting that the mobile device has a particular orientation;
receiving a plurality of distinct accelerometer output signal set that meet a set of constraints;
determining that the reception of the plurality of distinct accelerometer output signal sets while the mobile device has the particular orientation corresponds to a request for a particular operation of the mobile device; and
directing a module on the mobile device to perform the particular operation.

34-35. (canceled)

36. A non-transitory machine readable medium storing a program for execution by at least one processing unit of a mobile device comprising a plurality of sensors, the program comprising sets of instructions for:
using output data from a first set of sensors to detect that the mobile device has a particular orientation;
while the mobile device has the particular orientation, using a second set of sensors to detect a plurality of motion-detected tap inputs that meet a set of constraints;
determining that the detected plurality of motion-detected tap inputs correspond to a request for a particular operation of the mobile device; and
directing a module on the mobile device to perform the particular operation.

37-38. (canceled)
